(19) United States
(12) Patent Application Publication
(10) Pub. No.: US 2025/0200129 A1
(43) Pub. Date: Jun. 19, 2025

(54) APPARATUS FOR PROVIDING CONTROL SIGNALS FOR QUANTUM COMPUTING SYSTEMS AND/OR CLASSICAL COMPUTING SYSTEMS

(71) Applicant: BASF SE, Ludwigshafen am Rhein (DE)

(72) Inventor: Michael KUEHN, Ludwigshafen am Rhein (DE)

(21) Appl. No.: 18/866,946

(22) PCT Filed: May 10, 2023
(86) PCT No.: PCT/EP2023/062393

§ 371 Date: Nov. 18, 2024

(30) Foreign Application Priority Data
May 16, 2022 (EP) 22173580.6

(51) Int. Cl. G06F 17/11; G06N 10/40; G06N 10/60

(52) U.S. Cl. CPC G06F 17/11; G06N 10/40; G06N 10/60

(57) ABSTRACT

The invention refers to an apparatus for providing control signals to one or more quantum computing systems and/or classical computing systems. A providing unit provides an optimization problem representation comprising an interaction part quantified by an interaction parameter. A problem providing unit provides an interaction problem indicative of an interaction parameter. A providing unit provides a workflow indicating for the optimization and the interaction problem which operations are to be performed on the quantum computing systems or the classical computing systems. The workflow causes that at least a part of the interaction problem is calculated on a quantum computing system and that the optimization problem is calculated on a quantum computing system and/or a classical computing system. A generation unit generates control signals for controlling the one or more quantum computing systems and/or the classical computing systems based on the workflow.

### FIELD OF THE INVENTION

The invention relates to an apparatus, a method and a computer program product for providing control signals to one or more quantum computing systems and/or classical computing systems for determining a solution of a problem. Further, the invention refers to a problem-solution apparatus, a problem-solution method and a problem-solution computer program product for determining a solution of a problem utilizing control signals generated by the apparatus. Moreover, the invention refers to systems for determining a solution of a problem utilizing the apparatus and the problem-solution apparatus.

### BACKGROUND OF THE INVENTION

In recent years, a plurality of different quantum computing hardware realizations and quantum computing paradigms have been developed. For example, many of these different hardware realizations and quantum computing paradigms can be regarded as referring to gate-based quantum computers and quantum annealers. However, thus far a single quantum computing paradigm that serves multiple application problems equally well has not been available. In particular, each of the different paradigms, in particular, gate-based quantum computing and quantum annealing, provide different advantages and disadvantages. For example, gate-based quantum computers are able to be utilized to calculate a broad variety of problems including, in particular, electronic structure problems, but are also very prone to errors and are thus difficult to scale up. Therefore, most of the gate-based quantum computers are currently limited to a rather small number of utilizable quantum elements and a small number of quantum operations that can be applied consecutively.

Hence, gate-based quantum computers are currently limited in the application to real-world problems. Quantum annealers, on the other hand, are, due to their specific calculation paradigm, more limited in applicability but are simpler to scale up and provide a larger number of utilizable quantum elements for specific problems. Based on this very diverse and in particular fast changing landscape of different quantum computing hardware solutions, it is very challenging to apply quantum computing to real-world scenarios, in particular, in the context of finding and developing new chemical and material workflows or synthesis processes. It would thus be advantageous to provide concepts that allow for an efficient and product-specific utilization of quantum computing in the solution of real-world problems.

### SUMMARY OF THE INVENTION

It is an object of the present invention to provide an apparatus, a method, and a computing program product that allow for an efficient utilization of quantum computers for solving optimization problems, in particular, in the context of developing new chemicals and materials or enhancing existing chemicals and materials. Moreover, it is an object of the present invention to provide a problem-solution apparatus, a problem-solution method and a problem-solution computer program product that utilize the apparatus, method and computer program product for efficiently and accurately solving an optimization problem. Further, it is an object of the invention to provide systems for determining a solution of a problem utilizing the apparatus, method and computer program product, and/or the problem-solution apparatus, problem-solution method and problem-solution computer program product.

In a first aspect of the invention, an apparatus for providing control signals to one or more quantum computing systems and/or classical computing systems for determining a solution of a problem is presented, wherein the problem is an optimization problem referring to an optimization with respect to at least two variables to find one or more optimal target quantities, wherein the apparatus comprises a) a problem providing unit for providing an optimization problem, wherein the optimization problem is translatable into an optimization problem representation comprising an interaction part, wherein the interaction part is indicative of a two-way or multi-way interaction between two or more variables of the optimization problem, wherein the interaction in the interaction part is quantified by an interaction parameter, b) a parameter problem providing unit for providing an interaction problem, wherein a solution of the interaction problem is indicative of the interaction parameter of the optimization problem, c) a workflow providing unit for providing a workflow for utilizing the one or more quantum computing systems for determining the one or more optimal target quantities, wherein the workflow indicates for each of the optimization problem and the interaction problem which operations for solving the respective problem are to be performed on which of the one or more quantum computing systems or the classical computing systems, wherein the workflow is provided such that it causes that at least a part of the interaction problem is calculated on a quantum computing system and that the optimization problem is calculated completely or partly on a quantum computing system and/or a classical computing system, d) a control signal generation unit for generating control signals for controlling one or more of the one or more quantum computing systems and the classical computing systems based on the workflow, wherein the control signals are generated based on the workflow such that i) the at least a part of the interaction problem is calculated on a quantum computing system and the interaction parameter is determined based on the quantum computer calculation, and ii) that the optimization problem is calculated completely or partly on a quantum computing system and/or a classical computing system based on the determined interaction parameter and that the optimal target quantities are determined based on the calculated solution of the optimization problem.

Since the control signals are generated based on the workflow that causes a calculation of at least a part of the interaction problem on a quantum computing system and further the calculation of the optimization problem based on the solution of the interaction problem completely or partly on a quantum computing system and/or a classical computing system, the quantum computing system can be utilized for solving the parts of the workflow for which a respective quantum computer is most suitable. Thus, the optimization problem can be solved with less computational resources, i.e. more efficiently, and due to the utilization of a quantum computer, in a less time-consuming manner. Moreover, the quantum computer also allows to solve the interaction problem more accurately, for instance, taking into account more variables, such that the interaction parameter can be determined more accurately, leading also to a more accurate determination of the target quantities of the optimization problem.

By performing operations for solving the respective problem on the one or more quantum computing systems or classical computing systems, according to the aspects of the invention, complex problems in the development of new chemicals and materials or in the enhancing of existing chemicals and materials may be solved in a more efficient way. By tailoring the workflow and the performance of respective operations on different hardware to the problem to be solved, a more efficient and reliable solution may be found. This not only enhances the synthesis of chemicals and materials, but also provides for better integration into laboratory operations. The number of experiments required can be greatly reduced and the tailoring of the chemicals or materials to certain performance requirements can be enhanced.

Preferably, the apparatus is configured for providing the control signals to one or more quantum computing systems and/or classical computing systems for determining a solution of a problem referring to a chemical product, more preferably, referring to the development of a new chemical product or the enhancing of an existing chemical product, even more preferably, referring to optimizing a chemical product associated with or comprising one or more potential chemical constituents with respect to selecting one or more constituents based on a performance objective. In particular, the apparatus is utilizable in such a process in a plurality of different ways, for instance, the optimization problem can refer to calculating a performance objective based on different one or more constituents of the chemical product or to determining a training data set for training a data-driven model to determine a respective performance objective.

Generally, the apparatus can be realized in form of software or hardware or a combination thereof, wherein the hardware can refer to any known dedicated or general classical computer hardware. For example, the apparatus can be realized as any known computational device, like a PC. However, the apparatus can also be realized as a cloud environment, computational network, etc., such that at least parts of the apparatus can also be realized as a network solution and thus can be spread over a plurality of computation devices.

The one or more quantum computing systems for which the control signals are provided can refer to any known kind of quantum computing system. The quantum computer is generally adapted to perform quantum manipulations of respective quantum elements based on control signals for determining a solution of a problem. Quantum manipulations can refer to any manipulations that are performed directly or indirectly on elements of the quantum computer that realize a quantum mechanical description of the problem. In case of a gate-based quantum computer the quantum manipulations are defined as quantum operations that refer to a sequence of defined direct quantum manipulations of the quantum elements and measurements of states of the quantum elements that define a quantum circuit. However, in case of a quantum annealer the quantum manipulations refer to a more indirect manipulation. For example, after the preparation of the initial state of the quantum elements an external field, for example, a magnetic field, and coupling strengths between quantum elements are slowly changed for evolving the state of the quantum elements into a final state.

Generally, although an element of the quantum computer can be utilized to realize the quantum mechanical description of a problem, i.e. can be described with the quantum mechanical rules, the element itself does not necessarily have to refer to a quantum mechanical system, e.g. an atom or ion. Preferably, the quantum manipulations comprise all operations that directly or indirectly can influence the states of quantum elements, i.e., qubits, of the quantum computer. In particular, the one or more quantum computing systems can refer to one or more adiabatic quantum computing systems, quantum annealing systems and/or gate-based computing systems. The one or more classical computing systems can refer to any known classical computing system, in particular, also to a distributed classical computing system utilizing a network of computers for calculation purposes.

Generally, the provided control signals refer to signals that cause the one or more quantum computing systems and/or classical computing systems to follow predetermined rules or algorithms to perform a respective calculation indicated by the control signals. In particular, the control signals can refer to signals that merely initialize such a respective calculation but can also refer to signals that determine the complete calculation which is performed by the respective computing system. Moreover, the control signals can already be provided in a format that allows for a direct execution of the control signals on the respective quantum computing system or classical computing system, but can also be provided in a format that first has to be translated into a format used for controlling the respective computing system.

For example, if the control signals specify specific manipulations that should be performed on the quantum computer, the signals indicting these manipulations can be translated by a control unit specific to the respective quantum computing system into signals interpretable by the quantum computing systems for performing the operations. In particular with respect to quantum computing systems, it might be necessary to transform a specific manipulation indicated by the control signals into respective specific control signals for controlling, for instance, a laser unit or an electromagnetic field providing unit to provide laser light or an electromagnetic field, respectively, that allows an intended manipulation of the quantum elements of the respective quantum computing system that correspond to the manipulation indicated by the control signals. Also in case of control signals provided to classical computing systems, a transformation can be applied, for instance, in order to distribute a respective classical computing operation or calculation on a network of computers forming the classical computing system.

The problem for which a determination of a solution should be performed refers to an optimization problem. Generally, an optimization problem refers to an optimization, i.e. minimizing or maximizing, of a functional relation between different quantities. The respective quantities can refer to variables that can be varied during the optimization of the problem.

Further, the quantities can refer to fixed or predetermined quantities that are not varied during the optimization of the problem. Moreover, the quantities can further refer to one or more quantities which are minimized or maximized during the optimization of the problem referred to as optimization quantities. In particular, the optimization of the optimization problem is performed with respect to one or more variables, i.e. with respect to one or more quantities that can be varied during the optimization in order to minimize or maximize the respectively to be optimized quantity. Such a variable can refer to a scalar variable, i.e. to a quantity that can take on only one value at a time, or can refer to a higher-dimensional variable, in particular, to a set of scalar quantities that can take on one value at a time, for instance, can refer to a vector or a matrix. Moreover, the variable can refer also to a part of a higher-dimensional quantity, for instance, can refer to one or more scalar quantities of a matrix or vector. Generally, the optimization problem can be provided such that the respective variables of the optimization problem can take on any value. However, in a preferred embodiment, the optimization problem is adapted such that the one or more variables are binary variables, i.e. can only take on two values, for example, the values 0 and 1 or 0 and −1 or 1 and −1. This is particularly preferred if the optimization problem is at least partly calculated on a quantum computer. In a more general case, it is preferred that the optimization problem is adapted such that the variables can take on any integer value. The one or more optimal target quantities in particular refer to one or more of the variables of the optimization problem that are varied during the optimization of the optimization quantity or to the one or more optimization quantities after the optimization. Thus, the optimal target quantities can be regarded as referring to the values of one or more variables or one or more optimization quantities at the end of the optimization process.

The problem providing unit is adapted to provide a respective optimization problem. In particular, the problem providing unit can refer to a storage unit on which the optimization problem is already stored. However, the problem providing unit can also comprise or refer to an input unit which can be utilized, for instance, by a user, to indicate a respective optimization problem to be provided by the problem providing unit. The optimization problem is generally provided such that it is translatable into an optimization problem representation that comprises an interaction part. The interaction part refers to the part of the optimization problem that is indicative of a two-way or multi-way interaction between two or more variables of the optimization problem. In particular, the interaction can also be between variables of a variable set, for example, between quantities within a vector or matrix forming a variable of the optimization problem. Generally, the interaction in the interaction part is quantifiable by an interaction parameter. In particular, the interaction parameter can be indicative of the kind of interaction and/or of the strength of the interaction between specific variables of the optimization problem. Generally, also more than one interaction parameter can be utilized to quantify the interaction in the interaction part, for instance, different interactions of the variables can be quantified by different interaction parameters. In particular, the interaction parameter can also take the form of a vector, matrix or tensor, or even higher-dimensional objects. The interaction parameters are generally not part of the optimization process and thus are determined before and not during the optimization of the optimization problem.

Generally, the problem providing unit can be adapted to provide the optimization problem in form of an optimization description indicative of the optimization problem preferably translatable into a quantum mechanical description, if at least a part of the optimization problem is to be calculated on a quantum computer. However, if the optimization problem is to be calculated on a classical computing system, it is not necessary that the optimization problem is translatable into a quantum mechanical description. The optimization description can refer to any form of description of the optimization problem that allows to determine the quantities describing the optimization problem and the form of interaction between these quantities. Preferably, the optimization description refers to a mathematical description of the problem. However, the optimization description can also refer to any other unambiguous form of notation of the optimization problem. In a preferred embodiment, the optimization description is already provided in form of a quantum mechanical description, wherein a quantum mechanical description represents the problem in terms of quantities following the quantum mechanical rules, i.e. refers to a representation of the optimization problem in the quantum mechanical world. However, the optimization description can also be provided in any other form, and the problem providing unit can be adapted to translate the provided optimization description into a quantum mechanical problem description, if part of the optimization problem is to be calculated on a quantum computer as indicated by the workflow. However, this translation can also be omitted, wherein in this case the control signal generation unit is preferably adapted to process the respective form of the optimization description accordingly, for instance, by utilizing principles derived from the processing of the optimization description in the quantum mechanical description.

Preferably, the optimization problem is associated with a chemical product, more preferably, with a development of a new chemical product or an enhancing of an existing chemical product, even more preferably, with optimizing a chemical product associated with or comprising one or more potential chemical constituents with respect to selecting one or more constituents based on a performance objective. In a preferred example, the performance objective is based on a magnetic property of a chemical product, in particular, a chemical product that can be represented as a solid material or spin system, and the optimization problem refers to calculating the magnetic property based on an Ising model. In another preferred example the performance property is based on a structure of a protein, for instance, can be derived from a known structure of a protein, and the optimization problem refer to determining the structure of the protein based on a protein optimization. In another preferred example, the performance objective is based on a technical target property of a chemical product and the optimization problem refers to generating a training data set, in particular, a feature selection, for training a data-drive model to predict a technical application property of a chemical product.

The parameter problem providing unit is adapted to provide an interaction problem. In particular, the parameter problem providing unit can refer to a storage unit on which an interaction problem is already stored. For example, for different optimization problems respective different interaction problems can be predetermined and stored in a functional relation such that the parameter problem providing unit can select and access the respective interaction problem for a provided optimization problem. However, the parameter problem providing unit can also comprise or refer to an input unit by which, for instance, a user can indicate a respective interaction problem, for instance, in a computer-guided interaction process where the user is presented with a predetermined selection of interaction problems and the user can then select a respective interaction problem that should be provided by the parameter problem providing unit. Preferably, the parameter problem providing unit is adapted to provide the interaction problem based on the provided optimization problem.

For example, a respective interaction problem can be stored in association with an optimization problem, such that the parameter problem providing unit can provide the associated interaction problem of the optimization problem. Generally, a solution of the interaction problem is indicative of the interaction parameter of the optimization problem. Thus, the interaction problem can be utilized to accurately determine the interaction parameter, in particular, for cases where the interaction parameter cannot easily be predetermined by general considerations with respect to the interaction. Generally, also more than one interaction problem can be provided, for example, for cases in which the interaction part of the problem comprises more than one interaction parameter that are independent of each other. In this case, for each independent interaction parameter of the interaction part the parameter problem providing unit can be adapted to provide a specific interaction problem that is indicative of the respective interaction parameter. A solution of the interaction problem is indicative of the interaction parameter of the optimization problem, wherein the interaction parameter is indicative of, in particular, quantifies, an interaction, in particular, a two-way or multi-way interaction, between two or more variables of the optimization problem. Generally, the optimization problem and the interaction problem are not the same, i.e. refer to completely different problems that only are related in the sense that the interaction problem determines the interaction parameters that are then used in the solution of the optimization problem.

Preferably, the interaction problem is associated with determining interaction parameters in the context of a chemical product, more preferably, in the context of the development of a new chemical product or the enhancing of an existing chemical product, even more preferably, in the context of optimizing a chemical product associated with or comprising one or more potential chemical constituents with respect to selecting one or more constituents based on a performance objective. The interaction problem preferably determines interaction parameters that are indicative of an interaction of features related to a chemical product. In a preferred example, the optimization problem refers to calculating a magnetic property of a chemical product based on an Ising model and the interaction problem determines a coupling strength between spins at different sites of the chemical product. In another preferred example the optimization problem refers to determining the structure of a protein based on a protein optimization and the interaction problem determines an interaction energy of different rotamers at different positions in the protein. In another preferred example, the optimization problem refers to generating a training data set, in particular, a feature selection, for training a data-drive model to predict a technical application property of a chemical product and the interaction problem determines a correlation coefficient describing a redundancy and/or correlation of the features.

Generally, the parameter problem providing unit can be adapted to provide the interaction 35 problem in form of an interaction description indicative of an interaction problem, preferably, being translatable into a quantum mechanical description. The interaction problem description can refer to any form of description of the interaction problem that allows to determine the quantities describing the interaction problem and the form of interaction between these quantities. Preferably, the interaction problem description refers to a mathematical description of the problem. However, the problem description can also refer to any other unambiguous form of notation of the problem. In a preferred embodiment, the interaction problem description is already provided in form of a quantum mechanical description, wherein a quantum mechanical description represents the interaction problem in terms of quantities following the quantum mechanical rules, i.e. refers to a representation of the interaction problem in the quantum mechanical world. However, the interaction problem description can also be provided in any other form, wherein in this case it is preferred that the parameter problem providing unit is adapted to translate the provided interaction problem description into a quantum mechanical problem description before providing the interaction problem description, for example, to the control signal generation unit. However, this translation can also be omitted, wherein in this case, for example, the control signal generation unit is preferably adapted to process the respective form of the interaction problem description accordingly, for instance, by utilizing principles derived from the processing of the interaction problem description in the quantum mechanical description.

The workflow providing unit is adapted to provide a workflow for utilizing the one or more quantum computing systems for determining the one or more optimal target quantities.

Preferably, the workflow is provided based on the optimization problem and/or the interaction problem. For example, a specific workflow can be stored associated with an optimization problem and/or an interaction problem and the workflow providing unit can provide the respectively stored workflow. However, the workflow providing unit can also be adapted to utilize predetermined rules to provide the workflow based on the optimization problem and/or the interaction problem. Moreover, further examples, are described, inter alia, in the following. The workflow indicates for each of the optimization problem and the interaction problem which operations for solving the respective problem are to be performed on which of the one or more quantum computing systems or the classical computing systems. In particular, the workflow can refer to any kind of format or data structure that indicates, for instance, to the control signal generation unit how the control signals have to be generated such that the respective operations are performed by the respective intended computing 30 system. For example, the workflow can refer to a simple table or list data structure that links the problems or parts of the problems, for instance, specific operations for solving the problems, to a respective computing system. However, the workflow can also be provided in a more complex data structure indicating in detail not only the problem or parts of the problem but all specific operations and how they have to be performed on which computing system.

However, the workflow is not provided in an arbitrary manner but is provided with respect to certain constraints that have been found by the inventors to solve the above discussed problem and allow for an efficient utilization of quantum computing systems for solving optimization problems. In particular, the workflow is provided such that is causes that at least a part of the interaction problem is calculated on a quantum computing system and that the optimization problem is calculated based on the calculation of the interaction problem completely or partly on a quantum computing system and/or a classical computing system.

Generally, the workflow providing unit only provides workflows that follow these constraints.

For example, the workflow providing unit can refer to or can have access to a storage unit on which a respective workflow is already stored, wherein, if necessary, the workflow providing unit can be adapted to check whether the stored workflow fulfils the above condition and only provide the workflow if the condition is fulfilled. However, the workflow providing unit can also refer or can be communicatively coupled to an input unit into which a user can input a respective workflow, wherein also in this case the workflow providing unit can be adapted to ensure that the respective condition for the workflow is fulfilled. For example, the workflow providing unit can notify the user of the condition and then only accept workflows that fulfil the condition. However, it is preferred that the workflow providing unit allows for a user-guided interaction process in which the user is guided during the input of the workflow such that the inputted workflow fulfils the condition. For example, a respective input unit can provide a representation of the interaction problem to the user and then allow the user to select on which quantum computing system the interaction problem should be calculated such that the thus generated workflow directly fulfils the condition that the interaction problem is solved at least partly by a quantum computing system. For the overall optimization problem, the input unit can then present the user with a selection possibility that also includes at least one classical computing system such that the user can select whether the overall optimization problem should be calculated on a quantum computing system or a classical computing system or partly on both.

In a preferred embodiment, the workflow providing unit refers to a workflow determination unit that is adapted to determine the workflow based on the optimization problem and/or the interaction problem, preferably, based on one or more characteristics of the optimization problem and/or the interaction problem. In particular, predetermined rules can be utilized for automatically determining the workflow based on the one or more characteristics of the optimization problem and/or the interaction problem. For example, the predetermined rules can indicate, based on the characteristics, for which part of the optimization problem and/or the interaction problem which respective computing system should be utilized. Generally, the characteristics of the optimization problem and/or the interaction problem can refer to any feature of the optimization problem and/or the interaction problem. For example, the characteristics can refer to the type, kind and number of variables or quantities of a respective problem, can refer to the kind and/or strength of interaction between the variables or quantities, can refer to a general structure of the respective problem, can refer to an application context of the respective problem, etc. Respective rules can then be provided, for instance, in form of a lookup table or functional relation that relates one or more values or value ranges of the characteristics to a respective computing system. For example, if a number of variables is higher than a predetermined threshold, the rules can indicate that the workflow should be determined such that the interaction problem is at least partly calculated by a quantum annealing system, whereas if the number of variables lies below a predetermined threshold, it is indicated that the interaction problem should be calculated at least partly on a gate-based quantum computing system. In particular, a respective threshold can be predetermined based on the number of usable quantum elements of the quantum computing systems available for the calculation. For instance, a first threshold can refer to the number of usable quantum elements of an available quantum annealing system and a second threshold can refer to the number of usable quantum elements of an available gate-based quantum computing system. In this case the number of variables can be first comparted with the second threshold, and if the number of variables lies blow the second threshold or is equal to the second threshold the gate-based quantum computing system is indicated by the workflow to be utilized. If the number of variables lies above the second threshold the number of variables can then be compared with the first threshold and if the number lies below the first threshold or is equal to the first threshold the workflow can indicate that a quantum annealing system is utilized. If the number of variables lies also above the first threshold, the workflow can indicate to utilize a classical computing system or to split the problem into one or more parts with less variables. Generally, a rule can be applied that determines that for calculating at least a part of the optimization problem, the interaction problem and/or the influence problem a quantum computing system is indicated in the workflow that provides a number of usable quantum elements that is equal or higher than the number of variables of the respective problem, i.e. the problem or the part of the problem that should be calculated on the quantum computing system. If a quantum computer that provides usable quantum elements for all variables of a problem is not available, the rules can cause to provide a workflow that indicates that only parts of such a problem are calculated on a respective quantum computing system. Moreover, the rules can also indicate that, if the problem comprises no parts that can be calculated on a quantum computer, the workflow is provided such that a classical computing system is utilized.

In this context the number of usable quantum elements generally depends on the specific characteristics of the quantum computing system, in particular, on the number of physical quantum elements, the decoherence, the known errors in the quantum manipulations, the connectivity between quantum elements, used error-correction algorithms, etc. In a further example, if the characteristics of the interaction problem indicate that the interaction problem can be represented in form of an electronic structure problem, the rules can indicate that the workflow should be provided such that the interaction problem is calculated at least partly on a quantum computing system referring to a gate-based quantum computing system. Moreover, in another example, if the characteristics of the optimization problem indicate that an estimation of a minimum energy gap between the ground state and the first excited state of a quantum mechanical description related to the optimization problem, in particular, of the Hamiltonian description utilized for representing the problem on a quantum annealer, is above a predetermined threshold, the rules can indicate to utilize a quantum annealer to calculate the optimization problem. Furthermore, a rule can determine that if the optimization problem comprises three or higher-way interactions, that it is preferred to utilize a gate-based quantum computing system for calculating the optimization problem.

Moreover, in a preferred embodiment the determination of the workflow can further be based on one or more technical characteristics of the available quantum computing systems and available classical computing systems. Such technical characteristics can refer, for instance, in case of quantum computing systems, to the number of qubits, the type of error correction utilized, known constraints in the applicable operations, the degree of connectivity between quantum elements, the decoherence times, etc. In case of classical computing systems the technical characteristics can refer, for instance, to a size of a main memory, the number of operations per time interval, storage capacity, number of available computer cores, etc. Also in this case, the respective technical characteristics can be connected in a kind of lookup table with characteristics of the optimization problem and the interaction problem and respective rules for which characteristics which available quantum computing system or classical computing system should be utilized, wherein examples of these rules are already provided above.

The control signal generation unit is adapted for generating control signals for controlling one or more of the one or more quantum computing systems and/or the classical computing systems based on the workflow. In particular, the control signals are generated based on the workflow such that a) the at least a part of the interaction problem is calculated on a quantum computing system and the interaction parameter is determined based on the quantum computer calculation, and that b) the optimization problem is calculated completely or partly on a quantum computer and/or a classical computing system based on the determined interaction parameter and such that the optimization target quantities are determined based on the calculated solution of the optimization problem. Generally, the control signals are generated based on the workflow. Thus, the workflow determines which computing systems of the one or more quantum computing systems and/or classical computing systems are controlled by the control signals. The control signals can thus be generated to control, for example, only one quantum computing system if the interaction problem and the optimization problem are completely solved by the same quantum computing system. In this context, it is noted that generally calculations performed on a quantum computing system are in most cases accompanied by calculations on classical computing systems, for instance, in order to determine from the measured observables on the quantum computing systems the solution of the respective problem. In the context of this invention, these generally known accompanying steps to the quantum computer calculations that are performed on classical computing systems can be regarded as being part of the controlling of the quantum computing system, although they do not refer to operations that are explicitly performed on the quantum computing system. Thus, referring to completely solving a problem on a quantum computing system can also include calculation steps performed on a classical computing system accompanying the calculations performed on the quantum computing system, if these are necessary, for instance, due to the nature of the quantum computing system, for solving the respective problem.

Generally, in case of control signals referring to the controlling of a quantum computing system, the controlling signal generation unit can be configured to generate control signals for controlling the quantum computer, in particular, by controlling a manipulation part of a quantum computer configured to manipulate the states of the quantum elements, in accordance with a corresponding sequence of manipulations. However, if the quantum computer itself already provides a controlling unit that is adapted to control the manipulation part such that the states of the quantum elements are manipulated, the controlling signal generation unit of the apparatus can be adapted to provide the controlling signals to the controlling unit of the quantum computer. In this case, for instance, the control signals can simply refer to a representation of a sequence of manipulations that can be interpreted by the controlling unit of the quantum computer to provide the respective control signals for controlling the parts of the quantum computer accordingly. However, the control signals can, in this case, also refer to generally known and interpretable control signals that are translated by the controlling unit of the quantum computer to respective dedicated control signals for controlling the specific hardware of the quantum computer. Thus, the control of the controlling signal generation unit of the apparatus can be directly or indirectly, depending on the respective realization of the one or more quantum computing systems. The controlling signal generation unit of the apparatus alone or together with an optional controlling unit of the one or more quantum computing systems can hence be regarded as referring to an interface between a quantum computing system, in particular, the hardware of the quantum computing system, and the software for solving a respective problem running on a generally known classical computer.

Further, the controlling signal generation unit can also be adapted for controlling a readout of the quantum computing system to measure, after the application of a sequence of predetermined quantum manipulations, at least one observable of the quantum mechanical state of the prepared representation of a solution of the problem. In particular, the control signals can be adapted to control a readout part of the quantum computer such that the one or more observables are measured, i.e. read out, after the preparation of the respective quantum state solving a respective problem has been completed. In particular, the controlling signal generation unit can be adapted to receive the readout of the readout part and provide the readout, for instance, to another apparatus for further processing the readout, for instance, in a classical computational environment. However, as described above, also here the control signal generation unit can interact optionally with a control unit of a quantum computer to act as an interface between a classical computer environment and the quantum computer.

In a most preferred embodiment the interaction problem refers to a quantum mechanical electronic structure problem, representing as chemical product, for example, a molecule. It is preferred that the operations for solving the interaction problem are performed on a gate-based quantum computer. Preferably, the the interaction parameter is then determined based on the quantum computer calculation. The interaction parameter can then be, for example, a physical property of a molecule, e.g. a total energy or a dipole moment. In particular, such interaction parameters are accessible in electronic structure calculations but often not directly translatable to an end technical application property, such as magnetism in a solid or the structure of a protein, etc. Based on the determined interaction parameter the optimization problem is solved to arrive at the technical application property of the chemical product.

In a preferred embodiment, the optimization problem further comprises an influence part indicative of an influence on one or more variables of the optimization problem, wherein the influence in the influence part is quantified by an influence parameter. The parameter problem providing unit is further adapted for providing an influence problem, wherein a solution of the influence problem is indicative of the influence parameter. The workflow is provided such that it causes that at least a part of the influence problem is calculated on a quantum computing system, wherein the control signals are generated based on the workflow further such that the at least a part of the influence problem is calculated on a quantum computing system and the influence parameter is determined based on the quantum computer calculation, and that the optimization problem is calculated further based on the determined influence parameter. Generally, the influence can refer to any influence on one or more respective variables that is not caused by the interaction with another of the one or more variables. In particular, it is preferred that the influence refers to an external influence, i.e. an influence affecting one or more variables but not being caused by any one of the other variables of the optimization problem. However, in some optimization problems the influence can also be an internal influence, i.e. an influence affecting one or more variables and being caused, for example, by the interaction of one or more other variables of the optimization problem with each other, wherein the internal influence does not refer to a direct interaction of the respective variables. In this preferred embodiment, the influence problem is calculated at least partly on a quantum computing system. This is in particular advantageous for complex influence problems that can be translated into a quantum mechanical description. However, in some embodiments, in particular, when the influence problem is less complex, it can also be advantageous to simply predetermine and thus provide the influence parameter for the influence part of the optimization problem. For example, in some cases databases with already calculated influence parameters can be utilized to predetermine or provide such an influence parameter. Moreover, in other embodiments, it can also be advantageous to utilize a classical computing system for calculating the influence parameter, for example, if already well-known and efficient algorithms exist for the calculation of the influence parameter that are based on operations on classical computing systems. Also in this case, in a preferred embodiment the workflow providing unit can be adapted to determine the workflow based on one or more characteristics of the optimization problem and/or the interaction problem and/or the influence problem in accordance with the above discussed rules and concepts.

In an embodiment, the workflow is provided such that it causes that at least a part of the interaction problem is calculated on a quantum computing system referring to a gate-based quantum computing system. It has been found by the inventors that the general structure of interaction problems in the context of optimization problems as described above allows for a very efficient calculation of the interaction parameter when utilizing a gate-based quantum computing system, in particular, in case the interaction problem refers to the form of an electronic structure problem.

In a preferred embodiment, the workflow is provided such that the optimization problem is calculated at least partly on a quantum computing system referring to an adiabatic quantum computing system, quantum annealing system or a gate-based quantum computing system. In particular, it is preferred that the workflow is provided such that the optimization problem is calculated at least partly on a quantum computing system referring to an adiabatic quantum computing system, or quantum annealing system. Also for this embodiment, it has been found by the inventors that optimization problems can be solved advantageously by quantum computing systems, in particular by quantum annealing systems.

In an embodiment, the workflow is provided such that the optimization problem is calculated at least partly on a quantum computing system referring to a quantum annealing system and wherein the control signal generation unit is adapted to generate the control signals for controlling the quantum annealing system such that i) the interaction parameters refer to a final coupling strength between quantum elements of the quantum computing system and ii) the variables of the optimization problem refer to quantum states of the quantum elements of the quantum computing system. In this context, the final coupling strength between quantum elements of the quantum computing system refers to the coupling strength between the quantum elements of the quantum computing system at the end of the quantum computer calculation, i.e. after the respectively desired state of the quantum elements of the quantum computing system is prepared. Moreover, the control signal generation unit can be adapted to generate the control signals for controlling the quantum annealing system such that the influence parameters refer to a final energetic bias between the states of a quantum element. This final bias can, for instance, be controlled by a magnetic field. In particular, the magnetic field can be used for manipulating one or more quantum elements such that the probability to find the quantum elements in a particular state at the end of the calculation is controlled.

Generally, it is preferred that the optimization problem is describable as a quadratic unconstrained binary optimization problem. In a preferred embodiment, it is preferred, that the optimization problem is describable in a mathematical representation referring to E(q)=Σᵢaᵢqᵢ+Σ_{i<j}bᵢⱼqᵢqⱼ, wherein the qᵢ refer to the variables of the optimization problem, the aᵢ refer to the influence parameters and the bᵢⱼ refer to the interaction parameters of the optimization problem, wherein the solution of the optimization problem is determined by optimizing the objective function E. In this embodiment, the qᵢ refer to binary variables that can only take on two values, for instance, the values 0 and 1. In particular in this description the optimization of the objective function E refers preferably to a minimization of the objective function E.

In an embodiment, the optimization problem refers to the calculation of magnetic properties in solid materials or spin systems that can be described utilizing an Ising model, wherein i) the optimization problem can be represented as a Hamiltonian of the Ising model, ii) the interaction parameter describes a coupling strength between spins at different sites in the solid material or spin system, and iii) the variables refer to the orientation of the spins at respective sites in the solid material or spin system. Moreover, an influence parameter in this case refers to a strength of an external magnetic field interacting with the spins of the solid material or spin system. In particular, for this case the optimizing of the optimization problem described utilizing an Ising model refers to a minimization of the energy of the respective system, wherein the Hamiltonian of the Ising model is indicative of the energy. For this embodiment, it is further preferred, that the interaction problem refers to an electronic structure problem and that the workflow is provided such that it causes the control signal generation unit to generate control signals for controlling a gate-based quantum computing system for providing a result utilizable for solving the electronic structure problem to determine the interaction parameter. It can be shown that in particular for this specific kind of problem gate-based quantum computing systems are in particular suitable for determining the respective interaction parameter.

In an embodiment, the optimization problem refers to a protein optimization for determining a structure of a protein, wherein i) the interaction parameter refers to an interaction energy of different rotamers at different positions in the protein and ii) the variables refer to respective rotamers at respective positions in the protein. Generally, the optimizing of the protein refers to a minimizing of the potential energy of the protein. Moreover, generally, a rotamer refers to isomers that can be interconverted just by rotations around formally single bonds. In particular, a rotamer can be regarded as a rotational isomer, i.e. an isomer arising from a hindered single-bond rotation, wherein a rotamer comprises a rotation barrier with a high enough energy such that the rotamer is substantially stable. Generally, in proteins rotamers describe the sidechain conformations of amino acid residues. Preferably, in this embodiment, the interaction problem refers to an electronic structure problem and the workflow is provided such that it causes the control signal generation unit to generate control signals for controlling a gate-based quantum computing system for providing a result utilizable for solving the electronic structure problem to determine the interaction parameter. In particular, the electronic structure problem is provided such that it is indicative of an interaction energy between different rotamers at respective positions in the protein. In a preferred embodiment, the protein optimization problem also comprises an influence parameter referring to an energy contribution of a rotamer at a respective position. The energy contribution can then be indicative of an internal energy of the rotamer at the position and/or of interactions of that rotamer at that position with fixed regions in the protein. In this embodiment the influence problem can refer also to an electronic structure problem and the workflow is preferably provided such that the influence problem is calculated by a quantum computing system, in particular, by a gate-based quantum computing system.

In an embodiment, the optimization problem refers to a feature selection problem for selecting a subset of features to predict a predetermined target property, wherein i) the interaction parameter refers to a correlation coefficient describing a redundancy and/or correlation of the features, and ii) the variables refer to a selection state of the respective features. Preferably, further an influence parameter is provided in the feature selection problem, wherein the influence parameter is indicative of a relevancy of a corresponding feature for the determination of the respective target property. The selected subset of features refers generally to the most relevant and least redundant features out of an initial set of features for determining a target property. In particular, the predetermined target property can refer to any target property, preferably to a technical application property of a material and/or chemical product. Preferably, the material and/or chemical product can be described by respective atoms or molecules, preferably, polymers, or substances, for example, referring to a mixture of molecules. The features to be selected can then refer to features of a respective material and/or chemical product that can be utilized for predicting the predetermined target property. For example, the features can refer to physical and/or chemical characteristics of the respective material and/or chemical product, for instance, can refer to respective descriptors. In this context the feature selection problem refers to selecting the features that allow for an optimal prediction of the predetermined target property from an initial set of features. Thus, the selection state of the respective features refers preferably to a binary variable that indicates in a first state, for instance, “0”, that a respective feature is not selected, and in the other state, for instance, “1”, that the respective feature is selected.

In this embodiment it is preferred that the workflow is provided such that it causes the control signal generation unit to generate control signals for controlling a quantum computing system such that a plurality of features of materials and/or chemical products are determined based on respective feature prediction problems and further to generate control signals to a classical computing system for determining based on the determined features the correlation coefficient of the respective features as interaction parameters. Thus, in this embodiment a quantum computing system is utilized for calculating predetermined features of respective materials and/or chemical products based on respective feature prediction problems. Such feature prediction problems can refer to any known problems that can be utilized for determining respective features of materials and/or chemical products. For example, quantum mechanical calculations can be utilized for determining quantum mechanical descriptors for molecules, polymers or solid materials. Further, in this embodiment the interaction problem preferably refers to the combination of the feature prediction problems and correlation and redundancy problems that determine a redundancy and/or correlation state as correlation coefficient between the determined features of a material and/or chemical product such that the redundancy and/or correlation state between respective features indicated by the correlation coefficients refers to the interaction parameters of the optimization problem. In a preferred embodiment the correlation coefficient refers to a Pearson correlation coefficient. Preferably, the part of the interaction problem referring to the calculation of the correlation and redundancy problems is performed utilizing a classical computing system. Preferably, the utilized quantum computing system for calculating the feature prediction problems refers to a gate-based quantum computing system. Moreover, it is preferred that the feature prediction problems refer to electronic structure problems that allow to determine respective characteristics, for instance, physical/chemical characteristics, of a material and/or chemical product.

In this embodiment it is further preferred the control signal generation unit is further adapted to generate control signals for controlling a training unit adapted to train a machine learning based property model, wherein the control signals cause the training unit to train the machine learning based property model based on the selected subset of features to predict a target property. In particular, in this embodiment it is preferred that a machine learning based property model is provided in form of an optimization problem, wherein an optimization of the optimization problem refers to an optimal parameterization of the machine learning based property model such that the machine learning based property model can predict a predetermined target property based on respectively provided features of a material and/or chemical product. In this case it is preferred that the training unit refers to or is adapted to control at least partly a quantum computing system, wherein any of the above described methods can then be utilized for training the machine learning based property model, wherein at least parts of the training are performed on the quantum computing system.

In a further aspect of the invention a problem solution apparatus for determining a solution of a problem is presented, wherein the problem is an optimization problem referring to an optimization with respect to one or more variables to find one or more optimal target quantities, wherein the optimization problem is translatable into an optimization problem representation comprising an interaction part, wherein the interaction part is indicative of a two-way or multi-way interaction between two or more variables of the optimization problem, wherein the interaction in the interaction part is quantified by an interaction parameter, wherein the apparatus comprises a) a parameter determination unit for determining a solution for the interaction problem, wherein the parameter determination unit is adapted to receive control signals generated by an apparatus as described above and to determine the interaction parameter based on the results of the calculation of the interaction problem on the quantum computing system and based on the control signals, and b) an optimization unit for solving the optimization problem, wherein the optimization determination unit is adapted to receive control signals generated by an apparatus as described above and to determine the one or more optimal target quantities based on the solution of the optimization problem calculated completely or partly on the quantum computing system and/or classical computing system and based on the control signals.

In a further aspect of the present invention a system for determining a solution of a problem is presented, wherein the system comprise a) an apparatus as described above, b) a problem solution apparatus as described above, and c) a user interface for providing an interaction between a user and the apparatus and/or the problem solution apparatus, wherein the interaction comprises providing input to the apparatus and/or the problem solution apparatus, wherein the user interface is further adapted to provide the one or more optimal target quantities to the user.

In a further aspect of the present invention a system for determining a solution of a problem is presented, wherein the system comprises a) one or more quantum computing systems, and b) a system as described above, wherein the system is communicatively coupled to the one or more quantum computing systems for providing control signals for controlling one or more of the quantum computing systems and receiving result signals indicative of results of calculations on the one or more quantum computing systems.

In a further aspect of the present invention a method for providing control signals to one or more quantum computing systems and/or classical computing systems for determining a solution of a problem is presented, wherein the problem is an optimization problem referring to an optimization with respect to one or more variables to find one or more optimal target quantities, wherein the method comprises a) providing an optimization problem, wherein the optimization problem is translatable into an optimization problem representation comprising an interaction part, wherein the interaction part is indicative of a two-way or multiway interaction between two or more variables of the optimization problem, wherein the interaction in the interaction part is quantified by an interaction parameter, b) providing an interaction problem, wherein a solution of the interaction problem is indicative of the interaction parameter of the optimization problem, c) providing a workflow for utilizing the one or more quantum computing systems for determining the one or more optimal target quantities, wherein the workflow indicates for each of the optimization problem and the interaction problem which operations for solving the respective problem are to be performed on which of the one or more quantum computing systems or the classical computing systems, wherein the workflow is provided such that it causes that at least a part of the interaction problem is calculated on a quantum computing system and that the optimization problem is calculated completely or partly on a quantum computing system and/or a classical computing system, d) generating control signals for controlling one or more of the one or more quantum computing systems and the classical computing systems based on the workflow, wherein the control signals are generated based on the workflow such that i) the at least a part of the interaction problem is calculated on a quantum computing system and the interaction parameter is determined based on the quantum computer calculation, and ii) that the optimization problem is calculated completely or partly on a quantum computer and/or a classical computing system based on the determined interaction parameter and that the optimal target quantities are determined based on the calculated solution of the optimization problem.

In a further aspect of the present invention a problem solution method for determining a solution of a problem is presented, wherein the problem is an optimization problem referring to an optimization with respect to one or more variables to find one or more optimal target quantities, wherein the optimization problem is translatable into an optimization problem representation comprising an interaction part, wherein the interaction part is indicative of a two-way or multi-way interaction between two or more variables of the optimization problem, wherein the interaction in the interaction part is quantified by an interaction parameter, wherein the method comprises a) determining a solution for the interaction problem, wherein the parameter determination unit is adapted to receive control signals generated by an apparatus as described above and to determine the interaction parameter based on the results of the calculation of the interaction problem on the quantum computing system and based on the control signals, and b) solving the optimization problem, wherein the optimization determination unit is adapted to receive control signals generated by an apparatus as described above and to determine the one or more optimal target quantities based on the solution of the optimization problem calculated completely or partly on the quantum computer and/or classical computer and based on the control signals.

In a further aspect of the present invention a computer program product for providing control signals to one or more quantum computing systems for determining a solution of a problem is presented, wherein the computer program product comprises program code means for causing the apparatus as described above to execute the method as described above.

In a further aspect of the present invention a computer program product for determining a solution of a problem is presented, wherein the computer program product comprises program code means for causing a problem solution apparatus as described above to execute a problem solution method as described above.

In a further aspect, a system for synthesizing or producing a chemical product is presented, wherein the system comprises i) an interface unit configured to provide constituents identifiers associated with constituents making up the chemical product and physical structure identifiers associated with the relative positions of constituents making up the chemical product, ii) a processor configured to a) determine a target quantity of one or more configurations of the chemical product based on an optimization problem solved utilizing any of the methods described above, b) determine a performance objective of the chemical product based on the determined target quantity, and c) select one or more chemical constituents based on the performance objective, and iii) an interface unit configured to provide a recipe for producing the chemical product based on the selected chemical constituents suitable to control and/or monitor a synthesis or production of a chemical product.

The interface unit can refer to any computation unit that allows an interfacing with a user and/or another computing system, for example, an input unit, a storage, etc. Moreover, the interface unit for providing constituents and the interface unit for providing a recipe can refer to the same interface unit that is then configured to provide both functions, but can also refer to different units. Moreover, the interface units can also be provided as part of an interface system for providing input to the processor and providing an output of the process, for example, to a user, or to another computational system. The constituent identifiers and the physical structure identifiers can accordingly be provided by a user utilizing a respective input unit or can already be stored on a storage communicatively coupled to the interface unit for accessing the storage. The constituents can refer to any parts of the chemical product, for example, monomers, molecules, parts of molecules, atoms, etc. The physical structure allows then to identify the relative positions of these constituents in the chemical product. For example, the physical structure indicates where in a polymer respective repeating units, for example, monomers, are positioned. Based on this information, for example, a respective optimization problem as described above can be formulated that describes the respective chemical product and/or one or more properties of the chemical product. A solution of the optimization problem, i.e. an optimization of the optimization problem, is then indicative of a target quantity, for instance, at least one of an energy, electron density, and structure, of one or more configurations of the chemical product. For solving the optimization problem the principles described above with respect to the methods and apparatuses described above are utilized. Based on the determined target quantity a performance objective can be determined. In particular, a performance objective can refer to any objective referring to a technical application performance of the chemical product. For example, the performance objective can refer to a target technical application property of the chemical product. Such technical application properties can be derived from the determined target quantity of the chemical product. In this case the determining of the performance objective can refer to validating if the chemical product fulfills the performance objective, for example, meets the target technical application property within predetermined limits. Based on the determination of the performance objective, for example, the validation of the chemical product, one or more constituents and, optionally, also a physical structure of the chemical product, can be selected that should form the final chemical product, i.e. the chemical product that meets the performance objectives. For this chemical product then a recipe can be provided, in particular, indicating the selected constituents and the physical structure of the chemical product.

In a further aspect, a method for synthesizing or producing a chemical product is presented, wherein the method comprises i) providing constituents identifiers associated with constituents making up the chemical product and physical structure identifiers associated with the relative positions of constituents making up the chemical product, ii) determine a target quantity of one or more configurations of the chemical product based on an optimization problem solved utilizing any of the methods described, iii) determine a performance objective of the chemical product based on the determined target quantity, and iv) select one or more chemical constituents based on the performance objective, and v) provide a recipe for producing the chemical product based on the selected chemical constituents suitable to control and/or monitor a synthesis or production of a chemical product.

In a further aspect of the invention a method for synthesizing or producing a chemical product is presented, wherein the method comprises a) generating a recipe for the chemical product utilizing any of the system and the method described above, and b) synthesizing or producing the chemical product based on the recipe by controlling synthesizing or production equipment, respectively, configured to synthesize or produce the chemical product.

In a further aspect a use of a recipe generated as described above for producing the chemical product based on the selected chemical constituents suitable to control and/or monitor a synthesis or production of a chemical product is presented.

It shall be understood that the apparatuses as described above, the methods as described above, the systems as described above and the computer program products as described above have similar and/or identical preferred embodiments, in particular, as defined in the dependent claims.

It shall be understood that a preferred embodiment of the present invention can also be any combination of the dependent claims or above embodiments with a respective independent claim.

These and other aspects of the present invention will be apparent from and illustrated with reference to the embodiments described hereafter.

### BRIEF DESCRIPTION OF THE DRAWINGS

In the following drawings:

FIG. 1 illustrates a state representation of a qubit as used in a quantum computing device,

FIG. 2 illustrates a schematic example of a quantum computing device with qubits as calculation unit,

FIG. 3 illustrates a schematic example method for generating a control signal to perform operations on a quantum computing device and for processing measurement signals from the quantum computing device,

FIG. 4 illustrates a schematic example of a hybrid system including a classical and a quantum computing device,

FIG. 5 illustrates a schematic example of a quantum computing device based on superconductors,

FIG. 6 illustrates a schematic example of a quantum computing device based on trapped ions,

FIG. 7 shows schematically and exemplarily an embodiment of a system for determining a solution of a problem,

FIG. 8 shows schematically and exemplarily a flow chart of a method for determining a solution of a problem,

FIG. 9 shows schematically and exemplarily a general optimization method for a chemical product utilizing the invention,

FIG. 10 shows schematically and exemplarily an application of the invention in a production environment,

FIG. 11 shows schematically and exemplarily an application of the invention to a research and development process for finding new materials or formulations, and

FIGS. 12 to 14 show schematically and exemplarily examples for workflows according to the invention for preferred applications.

### DETAILED DESCRIPTION OF DRAWINGS

In the following first a short introduction into the general basic principles of quantum computers and the performance of calculations of quantum computers will be provided. Further, general principles can also be found in “Quantum Computation and Quantum Information: 10th Anniversary Edition”, M. A. Nielsen and I. L. Chuang (2010).

Classical computing devices use processors which are based on transistors. The state of each transistor has two controllable states 1 or 0 representing a digital binary or a bit. To perform operations on a classical computing device a human readable program code is translated via a compiler into machine-readable instructions. Machine-readable instructions are control signals, e.g. voltage settings, for each transistor. Representations of the machine-readable instructions may include binary or hexadecimal representations. Based on such machine-readable instructions, the operations are performed on the processor of a classical computing device.

Quantum computation is a relatively new computation method that uses quantum effects, such as superposition and entanglement, to perform certain computations more efficiently than classical digital computers. In contrast to digital computers, which represent information in the form of bits (e.g., “1” or “0”), as described above, quantum computing devices, i.e. quantum computers, use qubits, i.e. quantum bits, to represent information. Quantum computing devices are based on quantum elements adhering to the physics of quantum mechanics, such as superconductors, ions, atoms, quantum dots, photons, particle spins, bosons or the like. These quantum elements may be manipulated in a controlled manner to perform operations.

Although qubits and their manipulation may be described in terms of their mathematical properties, each such qubit may be implemented in a physical quantum element in any of a variety of different ways. Examples of such quantum elements include superconducting materials, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or any medium that exhibits qubit behavior comprising quantum states and transitions there between that can be controllably induced or detected.

Generally, for any given physical quantum element that implements a qubit, any of a variety of properties of that physical unit may be chosen to implement the qubit. For example, if electrons are chosen to implement qubits, then the x, y or z component of an electron spin degree of freedom can be chosen as the property of such electrons to represent the states of such qubits. For any particular degree of freedom, the physical quantum elements can Text use be controllably put in a state of superposition or entanglement and measurements can then be taken in the chosen degree of freedom to obtain readouts of qubit values.

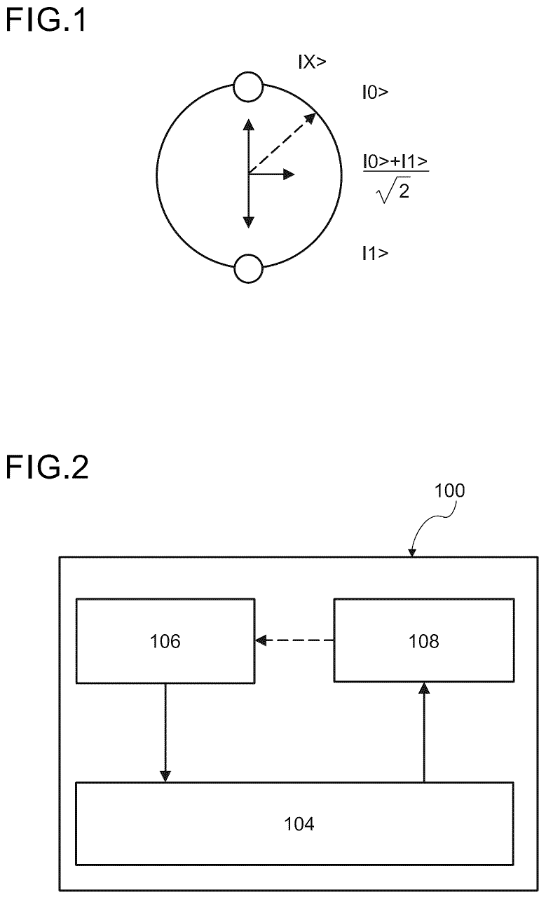

In contrast to transistors of classical computing device each quantum element of quantum computing devices can not only take the basis states |1 [symbol] or |0 [symbol] but also any superposition of such basis states, such as state |X [symbol] . The state of each quantum element is represented by a state of a quantum bit, i.e. qubit, as illustrated in the two-dimensional simplification of FIG. 1. To represent such states Dirac notation is commonly used in quantum mechanics. In Dirac notation a state in a n dimensional, complex vector space, such as a Hilbert space, is represented in braket notation, for example |X [symbol] . According to conventional terminology, the superposition of “0” and “1” states in a quantum computing device can be represented as α|0 [symbol] +β|1 [symbol] . The states “0” and “1” or bits of the classical computing device are similar to the basis states |0 [symbol] and |1 [symbol] or quantum bits of the quantum computing device, respectively. The value |α|² represents the probability that the qubit will be measured in the |0 [symbol] state, while the value |#|² represents the probability that the qubit will be measured in the |1 [symbol] state. If more than one qubit is present, two or more qubits may be entangled. Entanglement means that the state of one qubit is dependent on the state of at least one other qubit and vice versa, wherein further in the entangled state the respective qubits cannot be regarded as individual qubits anymore. Generally, a register of N qubits in a quantum computer can be put into a superposition of basis states at once whereas a register of N classical bits can only be in a single basis state at once. Thus, in contrast to classical computing devices on a quantum computing device 2^{N} basis states can be manipulated and processed simultaneously allowing for exponential intrinsic parallelism.

To perform operations on the quantum computing device the computational method to solve a given problem may be translated into qubit manipulations, which may be translated into control signals for manipulating qubits. Representations of the machine-readable instructions may include common quantum mechanical representations of operations in the Hilbert space. Depending on a specific realization of the quantum computer different representations of the qubit states may be chosen. Any state preparation on the quantum computing device may be represented by a manipulation acting on the qubit states. A manipulation may be translated into control signals to control a respective part of the quantum computer, which depend on the type of quantum computing device used. This way based on the manipulation acting on the qubit states, operations may be performed on the quantum equivalent of a classical processor as part of the quantum computing device.

In gate-based quantum computer systems the manipulations acting on the qubit states may generally be one or multi-qubit operations. A one-qubit operation may change the state of one t a specific superposition which corresponds to a rotation of the vector |X [symbol] as illustrated in FIG. 1. For example, in a superconducting quantum computer this can be accomplished by microwave pulses or in a trapped-ion quantum computer by irradiation of the ion with a laser beam. A multi-qubit operation may create entanglement between two or more qubits. For example, in a superconducting quantum computer this may be achieved by connecting qubits via an intermediate electrical coupling circuit or in a trapped-ion quantum computer via controlling the collective vibrations of the trapped ions.

Generally, to prepare manipulations for solving a given problem on a quantum computer a respective quantum mechanical representation of the problem may be translated into qubit manipulations, which are carried out to prepare a solution of the given problem. After the preparation of the predetermined solution, i.e. after the application of the operations to the qubits of the quantum computer, a projective measurement of all individual qubits is carried out returning either 0 or 1 for each qubit. On the quantum computing device this measurement is achieved by applying a hardware-specific readout protocol of a series of readout manipulations including, for example, in the case of gate-based quantum computers, control pulses and monitoring the response to control pulses. For example, a superconducting qubit may be coupled to a hardware resonator. The measured shift of the resonator frequency allows to determine the state of the qubit as this shift depends on the state of the coupled qubit. In case of trapped ions, for example, an optical readout may be used, e.g. the state of the qubit is 1 if the ion emits light or 0 if the ion does not emit light or vice versa. This way qubits may be used, in particular, on gate-based quantum computers, to implement logical circuits or gates as in classical computing devices.

In FIG. 2 a schematic example of a quantum computer is illustrated. The quantum computing device 100 shown in FIG. 2 includes a quantum register 104 configured to perform the quantum computation, a manipulation part 106 configured to manipulate the quantum register, in particular, quantum elements forming the qubits, and a readout part 108 configured to collect measurement signals from the quantum register 104 for reading out the qubits after a quantum mechanical calculation. The manipulation part 106, in particular, provides manipulation signals for manipulating the quantum register, wherein the manipulation signals are generated based on received control signals that are determined based on the respective operations that should be performed on the qubits. In some embodiment a feedback loop between the manipulation part 106 and measurement part 108 can be provided. In contrast to classical computing, where one measurement cycle provides the state of a transistor, quantum computing includes performing multiple measurement cycles to provide a probability density or a probability for the qubit states in case of gate-based quantum computers or to determine the measurement with the lowest energy in case of a quantum annealer.

The quantum register 104 can be based on different quantum elements representing the qubits. In some embodiments of gate-based quantum computers the qubits may be implemented by photons as quantum elements. Such optical quantum computing devices may include lasers that generate photons that are provided to a waveguide. A beam splitter can be provided for manipulating the photon states based on manipulation signals such as a mechanical rotation applied to a mirror. The measurement part 108 can in such an embodiment be a photon detector, and the measurement signals can be photons.

In other embodiments of gate-based quantum computers the qubits can be implemented by electronic states of ions trapped in a magnetic field. The manipulation part 106 can in such a case utilize a laser, and the manipulation signals can cause the providing of control laser pulses. Moreover, in this case, the readout part 108 can be a photon detector combined with read-out laser pulses, and the measurement signals 102 may be photons. Other qubit implementations may be based on superconductors as quantum elements, semiconducting material with anyons as quantum elements, or the like.

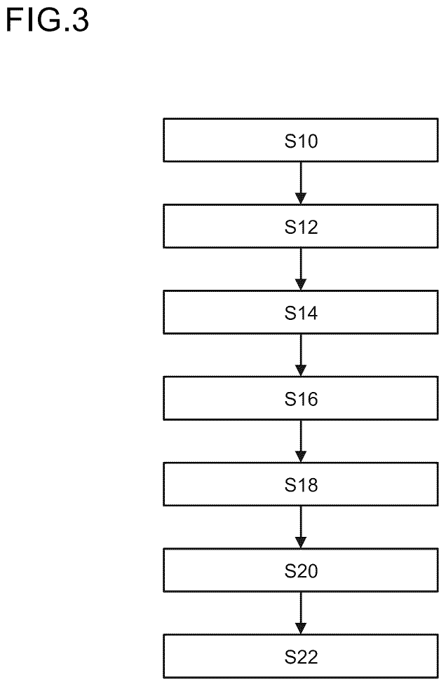

FIG. 3 illustrates a schematic exemplary method for generating a control signal to perform manipulations on a quantum computer and for processing measurement signals from the quantum computing device. In most embodiments of quantum computing devices known to date, the control signals for the quantum computing device are prepared on a classical computing device and the measurement signals provided by the quantum computing device are further processed on the classical computing device. Other embodiments are, however, conceivable as quantum computing devices mature. In the following example, the quantum computer refers to a gate-based quantum computer for which the manipulations refer to operations on the quantum elements of the quantum computer.

For generating the control signal to perform operations on the quantum computing device, the problem to be solved with the aid of the quantum computing device is provided in step S10, preferably, in a mathematical description. Such problem may for instance include determining a material property based on the mathematical description of the material's electronic structure. Other problems may include optimization problems and associated objective functions. Based on the problem to be solved, an operation description of the problem or a sub-problem may be generated in step S12, wherein the operation description comprises the operations to be applied to the qubits of the quantum computer to solve the problem in the quantum mechanical calculation. Further, the operation description can include a reference state that allows to generate a representation of an initial qubit state on the quantum computer on which the further operations are then applied by manipulating the qubit states. Based on the operation description control signals can then be generated in step S14 to control the quantum computer, for instance, by providing the control signals to the manipulation unit that can then manipulate the qubit states based on the control signals. In step S16 the manipulation unit then applies the manipulation operations to individual or multiple qubits of the quantum computer, wherein based on the manipulation operations the qubits perform the quantum mechanical calculation. After the manipulation, measurement signals can be generated to determine the result of the quantum mechanical calculation in step S18. This step can include a read-out, i.e. measurement, of the qubit states after applying the manipulation operations to the initial qubit states. The measurement signals can in step S20 then be translated into a measured quantity on the classical computer and in case of a sub-problem fed back into the problem to be solved. Finally, the result of the problem calculation including the quantum mechanical calculation can be provided on the classical computing device in step S22.

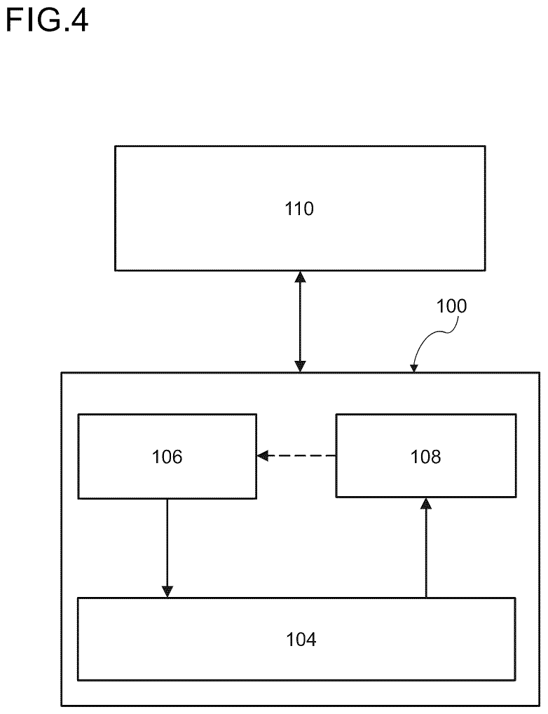

FIG. 4 illustrates a schematic example of a hybrid system including a classical and a quantum computing device. As described with respect to the method illustrated in FIG. 3, quantum computing devices are often used in connection with classical computing devices. As shown in FIG. 4 a problem preparation system can be realized as a classical computing device 110 performing, for instance, steps S10, S12, S20, S22 of the method illustrated in FIG. 3. A controlling unit can then be provided as interface between the classical computing device 110 and the quantum computer 100, wherein the controlling unit can also be a classical computing device, for instance, performing step S14. The control unit can then be communicatively coupled with the manipulation part 106 that can control the manipulators of the quantum computing device. Also, the manipulation part 106 can be realized as a classical computing device, for instance, a classical controlling hardware for the control of specific hardware components of the quantum computer that perform the manipulation of the qubits. However, the manipulation part 106 is generally regarded as part of the quantum computer, since it directly influences the quantum register. The quantum computing device 100 is adapted to perform the quantum operations in step S16, in particular, by the manipulation of the qubits of the quantum register. The measurement part 108 that is also generally regarded as part of the quantum computing device can then perform the step S18 by utilizing classical hardware. The measurement part 108 can then be communicatively coupled to the preparation system 110 for further processing of the measurement signals.

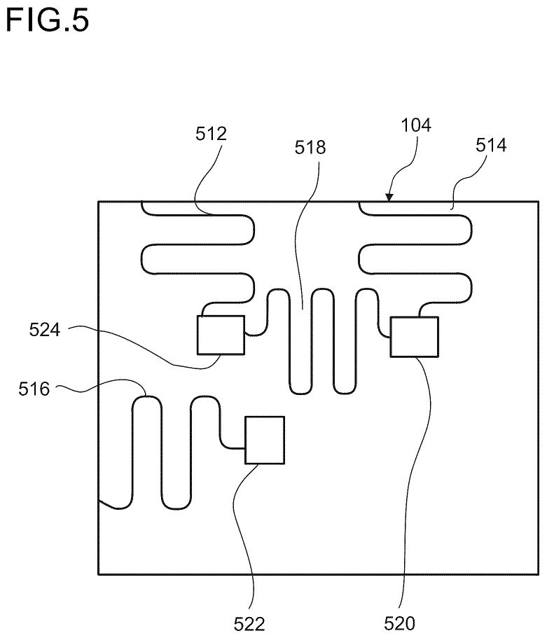

FIG. 5 illustrates a schematic example of a quantum computing device based on superconductors. Superconducting quantum computing devices are one of the solid-state quantum computing technologies. Here the quantum register 104 can include superconducting circuits 520, 522, 524 based on Josephson junctions. The qubits can then, for instance, refer to charge, flux, transmon, or phase qubits depending on the quantity of the superconducting circuits that are chosen to represent the qubits. FIG. 5 refers to a simplified illustration of a superconducting quantum computer utilizing charge qubits. For charge qubits the different states of the qubit are represented by an integer number of Cooper pairs on a superconducting island. In case of gate-based quantum computing quantum manipulations can then be performed by manipulating the qubits through microwave pulses. Resonators 512, 514, 516 can be utilized to manipulate the state of the qubits by applying the microwaves or for reading out the state of the qubits by measuring respective microwaves, wherein generally different resonators are used for the manipulation of the state of the qubits and the readout of the qubits. Moreover, resonator 518 can be utilized for applying microwaves that entangle the qubits. However, instead of resonator 518 the entanglement can also be achieved by an inductive or capacitive coupling of the superconducting circuits or even by providing another qubit, here a superconducting circuit, between the two be entangled qubits.

On an operational level such systems are maintained at extremely low temperatures, e.g., in the tens of mK. The extreme cooling of the systems keeps superconducting materials below their critical temperature and helps to avoid unwanted state transitions. To maintain such low temperatures, the quantum information processing systems may be operated within a cryostat, such as a dilution refrigerator. In some implementations, control signals are generated in higher-temperature environments, and are transmitted to the quantum computer using shielded impedance-controlled GHz capable transmission lines, such as coaxial cables. In some implementations, the state measurement of superconducting qubits is achieved using a dispersive detection scheme. In order to read out or detect the state of any qubit, a probing signal, e.g., a travelling microwave, may be excited along a readout transmission line coupled to the qubit via a respective readout resonator. The frequency of the probing signal can be in the vicinity of the resonance frequency of the readout resonator. Depending on the internal quantum mechanical state of the qubit, the intensity or phase of the probing signal transmitted along the readout transmission line may be altered because the reflectivity of the readout resonator coupled to the qubit changes depending on the state of the qubit. This allows for the state detection of the qubits, wherein during the readout of a qubit state the state of the qubit collapses, i.e. is projected with the respective probability onto one of the basis states. By performing the quantum mechanical calculation and the readout a plurality of times, for example, respective probabilities can be 10 determined. Further details for superconducting quantum devices are described e.g. in documents EP 3830867 A1, EP 3449427 A1, US 2020272925 A1, CN 212061223 U and US 2019019099 A1.

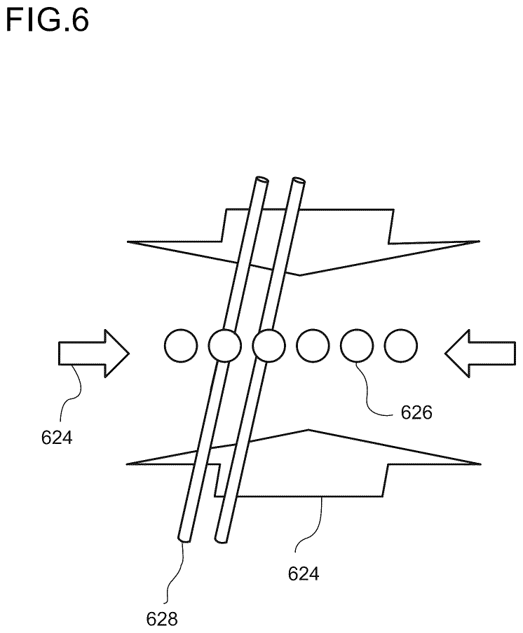

FIG. 6 illustrates a schematic example of a quantum computing device based on ions in an ion trap. Similar to neutral atom traps ion traps with, e.g. positively charged Calcium ions, can be used to implement the quantum computing device. Here ions 626 are trapped in an oscillating electromagnetic field 624 inside a high or ultra-high vacuum. The ions 626 are laser cooled and held in the oscillating electrical field 624. For qubit manipulation such as superposition or entanglement laser light 628 at different frequencies may be used.

Generally, based on the above described quantum computer realizations gate-based type 20 calculations can be performed on a quantum computer hardware architecture. The gate-based type calculation is based on quantum gates. In contrast to classical gates, there is an infinite number of possible single-qubit quantum gates that can change the state vector of a qubit. Changing the state of a qubit state vector typically is referred to as a single qubit rotation, and may also be referred to herein as a state change or a single-qubit quantum gate operation. A rotation, state change, or single-qubit quantum gate operation can be represented mathematically by a unitary 2×2 matrix with complex elements. A rotation corresponds to a rotation of a qubit state within its Hilbert space, which can be conceptualized as a rotation of a vector on the Bloch sphere, wherein the Bloch sphere is generally known as a geometrical representation of the space of the pure states of a qubit. Multi-qubit gates alter the quantum state of a set of qubits. For example, two-qubit gates rotate the state of two qubits as a rotation in the four-dimensional Hilbert space of the two qubits, wherein, as generally known, the Hilbert space is an abstract vector space possessing the structure of an inner product that allows length and angle to be measured. Furthermore, Hilbert spaces are complete, i.e. there are enough limits in the space to allow the techniques of calculus to be used.

In the following the term operation description refers to a representation of a problem that comprises either a sequence of quantum operations that should be applied during a quantum mechanical calculation of the problem on a gate-based quantum computer or to the manipulations performed on the quantum elements during a quantum mechanical calculation of the problem on a quantum annealer. The term “quantum manipulation” can include in the context of this invention all types of quantum gates as described above and all manipulations known for quantum annealers as will be described in more detail below. Further, in some applications the quantum manipulations can also include measurement manipulations. This allows to implement algorithms using a measurement feedback. For example, in such an algorithm a quantum computer can execute the quantum gates defined by the sequence of quantum manipulations and then measure only a subset, i.e., fewer than all, of the qubits or other calculation elements, like the bosonic field states, in the quantum computer, and then decide which further quantum manipulations to execute next based on the outcome of the one or more measurements. In particular, measurement feedback can be useful for performing quantum error correction, but is not limited to use in performing quantum error correction.

Not all quantum computers are gate-based quantum computers. Embodiments of the present invention are not limited to utilizing gate-based quantum computers. As an alternative example, embodiments of the present invention can also utilize, in whole or in part, a quantum computer that is implemented using a quantum annealing paradigm which is an alternative to the gate-based quantum computing paradigm. More specifically, quantum annealing is a metaheuristic for finding the global minimum of a given objective function over a given set of candidate solutions (candidate states), by a process using quantum fluctuations. In particular, quantum annealing is closely related to adiabatic quantum computing.

Generally, also quantum annealing procedures start with utilizing a classical computer providing or generating an initial Hamiltonian and a final Hamiltonian based on a computational problem to be solved, and providing the initial Hamiltonian, the final Hamiltonian and an annealing schedule as input to a quantum computer. In case of an annealing procedure in which an optimization problem is solved, preferably, the final Hamiltonian refers to an Ising Hamiltonian representing the optimization problem, or to a good approximation of the ground state of the Ising Hamiltonian representing the optimization problem. The quantum computer is then adapted, for instance, by utilizing a respective control unit controlling a manipulation part of the quantum computer, to prepare a relatively easy to prepare initial state, such as a quantum-mechanical superposition of all possible states, e.g. candidate states, with equal weights, based on the initial Hamiltonian. After the preparation of the initial state on the quantum computer, the initial state is then evolved according to the annealing schedule following a time-dependent Schroedinger equation referring to a natural quantum-mechanical evolution of the physical system of the quantum computer. More specifically, the state of the quantum computer undergoes time evolution under a time-dependent Hamiltonian, which starts from the initial Hamiltonian and terminates at the final Hamiltonian. If the evolution rate is slow enough, the system stays close to the ground state of the instantaneous Hamiltonian. At the end of the time evolution, the set of qubits, i.e. quantum elements, on the quantum annealer is in a final state, which is expected to be close to the ground state of the Ising Hamiltonian that corresponds to a solution to the original problem, referring, for instance, to an optimization problem. The final state of the quantum computer can then be measured, thereby producing results that can be utilized for solving the original problem. The measurement operation can be performed, for example, in any of the ways described already above. A classical computer can then perform postprocessing on the measurement results to produce an output representing a solution to the original computational problem. A quantum annealer as described above can, for instance, be realized on a superconducting quantum computer hardware.

Moreover, embodiments of the present invention can also utilize, in whole or in part, quantum computers that are implemented using a one-way quantum computing architecture, also referred to as a measurement-based quantum computing architecture. More specifically, the one-way or measurement-based quantum computer refers to a method of quantum computing that first prepares an entangled resource state, usually a cluster state or graph state, then performs single qubit measurements on it. It is “one-way” because the resource state is destroyed by the measurements. In such an architecture, the outcome of each individual measurement is random, but they are related in such a way that the computation always succeeds. In general, the choices of basis for later measurements need to depend on the results of earlier measurements, and hence the measurements cannot all be performed at the same time.

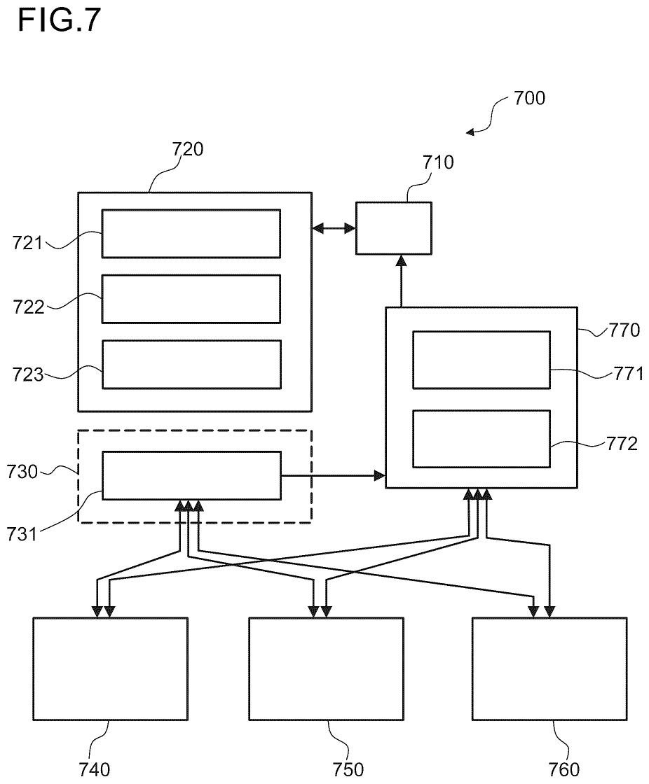

FIG. 7 shows schematically and exemplarily a system 700 for determining a solution of a problem. In this exemplary embodiment the system 700 comprises an optional user interface 710, a control signal providing apparatus 720, a control unit 730 and a problem solution apparatus 770. Further, the system 700 is communicatively coupled with one or more quantum computing systems and classical computing systems, for instance, schematically shown as a gate-based quantum computing system 740, a quantum annealing system 750, and a classical computing system 760, for instance, a classical calculation unit that can be realized in any known form, for example, as distributed computer network, computer cluster or workstation. Generally, the control signal providing apparatus 720 and the problem solution apparatus 770 can be provided as part of the same classical computing system and can, for instance, also be realized as part of the classical computing system 760. However, the control signal providing apparatus 720 and the problem solution apparatus 770 can also be provided independent from each other, for instance, in form of a distributed computing system.

The user interface 710 allows generally for a communication of a user with a control signal providing apparatus 720 and the problem solution apparatus 770, in particular, for providing input and/or for receiving output from the respective apparatuses. For example, it is preferred that a user interface 710 is realized in form of a user application that can be utilized on any known user computing device, like a smart phone, a laptop, a tablet, or a personal computer. However, in some embodiments of the system 700 such a user interface 710 can also be omitted, in particular, if an input is automatically provided, for instance, from a storage and if an output is also automatically provided, for instance, to a storage.

The control signal providing apparatus 720 is adapted to provide control signals to one or more quantum computing systems and/or classical computing systems, for instance, quantum computing systems and classical computing systems 740, 750 and 760. The control signal providing apparatus 720 comprises a problem providing unit 721, a parameter problem providing unit 722 and a workflow providing unit 723. Further, the control signal providing apparatus 720 comprises a control signal generation unit 731. The control signal generation unit 731 is in this example schematically shown as part of a control unit 730 in order to indicate that the control signal generation unit 731 can be part of the same computing system as the other units of the control signal providing apparatus 720 but can also be realized on a different computing system, for instance, on one or more of the computing systems utilized for generally controlling the quantum computing systems 740 and 750 or the classical computing system 760. Moreover, the control signal generation unit 731 can also be distributed between the different hardware components or realized as a stand-alone device that is communicatively coupled with the other computing systems and apparatuses.

The problem providing unit 721 is adapted to provide an optimization problem. In particular, the problem providing unit 721 is preferably adapted to receive an optimization problem from the interface unit 710. However, the problem providing unit can also refer to or can be communicatively coupled with a storage unit on which the optimization problem is stored.

Moreover, the problem providing unit 721 itself can also be realized in form of an interface allowing to interface, for instance, with the user for providing the optimization problem. For example, the problem providing unit 721 can be adapted to provide different possible forms of an optimization problem to a user, wherein the user is then allowed to select a respective optimization problem to be solved. However, a user can also directly input, for instance, with a keyboard or a mouse, an optimization problem or indicate storage space on which a respective optimization problem is stored. The optimization problem is generally translatable into an optimization problem representation comprising an interaction part. The interaction part is indicative of a two-way or multi-way interaction between two or more variables of the optimization problem and the interaction in the interaction part is quantified by an interaction parameter. Further general details, examples and preferred applications of a respective optimization problem will be discussed in further detailed examples of the invention below.

The parameter problem providing unit 722 is adapted to provide an interaction problem. The parameter problem providing unit 722 can be realized as or communicatively coupled to a user interface, like user interface 710. Moreover, the parameter problem providing unit 722 can also be realized as or communicatively coupled to a storage unit on which respective interaction problems are already stored. Accordingly, a respective interaction problem associated with the optimization problem can be directly provided as input by a user on the user interface 710, for example, via a selection option, or can already be stored on a storage unit. For example, for respective optimization problems a corresponding interaction problem can be predetermined and stored on a storage unit such that with the indication of a respective optimization problem the parameter problem providing unit 722 can access the storage unit and receive the corresponding interaction problem. In cases in which more than one interaction problem can be associated with an optimization problem a respective selection can be provided to the user and the user can be prompted to select the respective interaction problem.

Generally, a solution of the interaction problem is indicative of the interaction parameter of the optimization problem. In many optimization problems, in particular, optimization problems comprising two-way or multi-way interactions between two or more variables of the optimization problem it is often difficult to directly predetermine and quantify the interaction between the variables. In these cases solving a respective interaction problem allows to more accurately determine the interaction parameter and thus to more accurately define the optimization problem based on the determined interaction parameter.

In a preferred embodiment the parameter problem providing unit 722 can further be adapted to provide an influence problem if the optimization problem further comprises an influence part indicative of an influence, for example, an external influence, on one or more variables of the optimization problem. A respectively provided influence problem allows to calculate a respective influence parameter quantifying the influence. With respect to the influence problem and influence parameter the same concepts as described above can be applied. In particular, a respective influence problem can also be provided by a user or can be predetermined and stored such that it can be accessed by the parameter problem providing unit 722. Moreover, in alternative embodiments the parameter problem providing unit 722 can also be adapted to directly provide an influence parameter for a respective optimization problem. For example, for some problems the influence parameter can be predetermined or can be set based on a specific application of the optimization problem. For these cases the influence parameter can be stored on a storage in association with a respective optimization problem, or a user can be prompted to select or input a respective influence parameter.

The workflow providing unit 723 is adapted to provide a workflow for utilizing the one or more quantum computing systems and classical computing systems 740, 750, 760. In particular, the workflow providing unit 723 can again also be realized as or communicatively coupled to a user interface like user interface 710 such that a user can input a respective workflow. However, the workflow providing unit 723 can also be realized or communicatively coupled to a storage unit already storing a respective workflow. For example, for different optimization problems and/or different interaction problems respective predetermined workflows can already be stored and the workflow providing unit 723 can be adapted to determine which stored workflow corresponds to the respective optimization problem and interaction problem. However, in a preferred embodiment the workflow providing unit 723 can also be realized as a workflow determination unit that is adapted to determine the respective workflow. For example, the workflow providing unit 723 can in this embodiment be adapted to utilize predetermined rules that indicate, in particular, determine, based on characteristics of the optimization problem and/or the interaction problem and optionally also based on technical characteristics of the quantum computing systems and classical computing system the respective workflow. In a case in which the optimization problem further comprises an influence part the workflow providing unit 723 can also be adapted to utilize rules that are further based on characteristics of the influence problem to determine a respective workflow.

Generally, the workflow indicates for each of the optimization problem, the interaction problem and optionally the influence problem which operation for solving the respective problem is to be performed on which of the one or more quantum computing systems or one or more classical computing systems 740, 750, 760. Thus, the workflow determines how the respective computing systems 740, 750 and 760 are utilized for solving the optimization problem. However, for all cases the workflow is set such that at least a part of the interaction problem is calculated on one of the quantum computing systems 740, 750. Thus, with respect to the interaction problem the workflow can only determine which of the respective quantum computing systems 740, 750 is utilized and which part or if the complete interaction problem is calculated by a quantum computing system. However, the workflow cannot be chosen such that the interaction problem is solved completely, for instance, on classical computing system 760. In particular, it has been found by the inventors that calculating the interaction problem partly or completely on a quantum computing system is in particular advantageous and allows for a much faster and more accurate solution of the overall optimization problem. With respect to the optimization problem the workflow can however indicate that the problem is calculated completely or partly on a quantum computing system and/or a classical computing system 740, 750, 760. Specific details of the workflow, for instance, which of the quantum computing systems 740, 750 is utilized for a specific interaction problem and which computing system, either one of the quantum computing systems and/or a classical computing system, is utilized for the overall optimization problem can be based on the specific problem characteristics and/or based on technical characteristics of the available quantum computing or classical computing systems. Respective examples and rules will be provided in more detail in later described more detailed embodiments and examples.

In an embodiment in which further an influence problem is provided, the workflow can also indicate on which of the computing systems 740, 750, 760 the respective influence problem is calculated. Preferably, the workflow is provided such that also the influence problem is calculated on one of the quantum computing systems 740, 750. However, in some embodiments it can also be advantageous to calculated the influence problem on a classical computing system 760.

The control signal generation unit 731 is adapted to generate control signals for controlling the one or more quantum computing systems 740, 750 and the classical computing system 760. The control signals are generated based on the workflow. In particular, the control signals are generated based on the workflow such that at least a part of the interaction problem is calculated on one of the quantum computing systems 740, 750. Moreover, the control signals indicate that the interaction parameter is then determined based on the quantum computer calculations, wherein, for instance, for the determination of the interaction parameters based on the quantum computer calculation also a classical computing system can be utilized. Further, the control signals indicate, based on the workflow, whether the optimization problem is completely or partly calculated on a quantum computing system and/or a classical computing system, wherein for the calculation of the optimization problem the determined interaction parameter is utilized.

Generally, the control signals generated by the control signal generation unit 731 can be provided in a format that directly allows for a controlling of a respective computing system. For example, the control signals can already comprise respective quantum manipulations that allow for a controlling of the manipulation part of a respective quantum computing system. However, the control signals provided by the control signal generation unit can also be provided in a more general format not directly specifying the manipulations, but specifying which problem or which part of the problem is to be calculated on which computing system. In this case respective controlling units of the respective computing systems, for instance, controlling units controlling, for instance, a laser as manipulation part of quantum elements of a quantum computing system can then utilize the control signals and translate the control signals of the control signal generation unit 731 into specific control signals that allow to control the manipulation part and perform the respective quantum operations.

The results of the calculations on the one or more respective computing systems 740, 750, 760 can then be provided, optionally together, with the control signals of the control signal generation unit 731, to the problem solution apparatus 770. The problem solution apparatus 770 comprises a parameter determination unit 771 and an optimization unit 772. The parameter determination unit 771 is adapted to determine a solution of the interaction problem and further optionally of an influence problem, if provided. In particular, the parameter determination unit 771 can receive the control signals of the control signal generation unit 731 and further the results of respective calculations on the computing systems 740, 750, 760 and determine the interaction parameter and optionally also the influence parameter based on the received results and based on the received control signals. For example, the control signals can indicate which calculation and operations are still necessary to determine from the respective result calculated on one of the computing systems 740, 750 and 760 the respective interaction parameter or optionally influence parameter. In a case, for instance, in which the influence problem is calculated on a classical computing system, like classical computing system 760, the parameter determination unit 771 and the classical computing system 760 can be utilized as part of the same hardware or hardware distribution. Generally, the parameter determination unit 771 can be adapted to utilize an iterative algorithm for determining a solution of the interaction problem and further optionally of an influence problem. For example, a calculation of the interaction problem on a quantum computing system can be repeated until a predetermined criterion is reached and the final interaction parameter is determined.

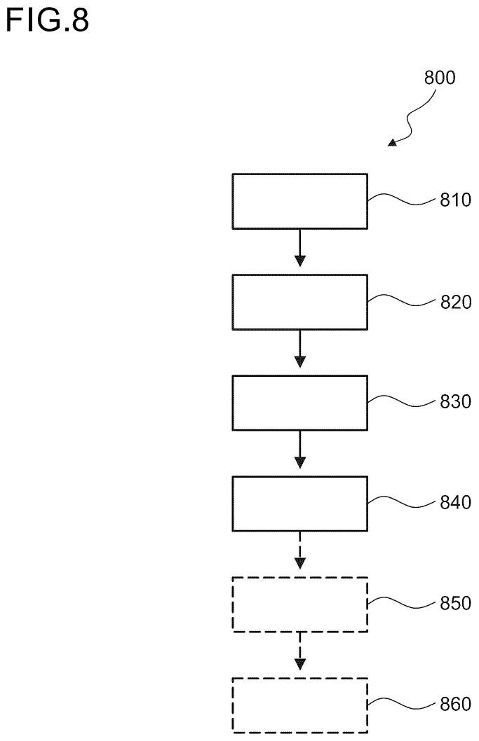

The optimization unit 772 is adapted to solve the optimization problem. In particular, after the calculation of the parameters, in particular, the interaction parameter and optionally the influence parameter, in accordance with the control signals, the respective parameters are utilized by the respective computing systems 740, 750, 760 for calculating the optimization problem. The results of the calculation can then be provided to the optimization unit 772 that is then adapted to utilize the results of the respective calculation to determine in accordance with the control signals the solution of the optimization problem. In particular, in some embodiments the solution of the optimization problem is calculated in form of an iterative calculation in which a plurality of iteration steps are utilized that lead to a repeated calculation of the optimization problem, for instance, on a quantum computing system 740, 750, processing of the results of the quantum computation in the optimization unit 772, and adapting of the problem calculation on the quantum computing system 740, 750 until a predetermined criterion is reached and it is determined that the final optimization state of the optimization problem is reached. In this case from this final state of the optimization problem the optimal target quantities can be determined by the optimization unit 772, for instance, as a value of the variables in the final optimization state. The optimization unit 772 can then provide the one or more optimal target quantities to the user interface 710 for providing the optimal target quantities as solution of the optimization problem to a user. FIG. 8 shows schematically and exemplarily a method for determining a solution of an optimization problem 800, wherein the method is provided in two different parts. The first part refers to the generating of control signals and comprises the steps 810 to 840 and the second part refers to the actual determination of the solution and comprises the steps 850 and 860. Generally, although the steps are schematically depicted in FIG. 8 as subsequently following each other, the interaction between the steps can also be more complex, for instance, some steps can be performed concurrently, in a different order or results of one step can be utilized in an iterative manner in a previous step. In particular, the method 800 follows the principles of the functions described above with respect to the system 700 for solving a problem as described with respect to FIG. 7. Moreover, for the details on steps for a specific preferred embodiment, examples and applications of the method 800 are described in the following more detailed examples. In step 810 the respective optimization problem to be solved is provided. Moreover, in step 820 a respective interaction problem and optionally also an influence problem associated with the optimization problem is provided. Generally, the providing of these problems follows the principles as described with respect to FIG. 7 and the steps 810 and 820 can be performed in any order or even at the same time. In step 830 a workflow is provided such that it causes at least a part of the interaction problem to be calculated on a quantum computing system and the optimization problem to be calculated completely or partly on a quantum computing system and/or a classical computing system. In particular, as already discussed above with respect to FIG. 7 the providing of the workflow in step 830 can also refer to a generating of the workflow in step 830, for instance, to a generating of the workflow based on predetermined rules and characteristics of the optimization problem and the interaction problem and optionally the influence problem. Preferably, also technical characteristics of the quantum computing and/or the classical computing systems are taken into account during the generation of the workflow. In step 840 control signals for controlling one or more of the quantum computing system and/or classical computing systems are generated based on the workflow, in particular, by following the instructions of the workflow indicating which parts of the respective problems are to be calculated on which computers. Generally, the first part of the method can be performed by a first provider that provides the respective generated control signals, for instance, to a customer who can then utilize respective control signals to perform the actual calculations. Thus, the actual calculations performed in steps 850 and 860 can then be performed by another provider or, for instance, by a customer device, on the same or a different computing system utilizing the control signals generated in step 840. In step 850 in particular, a solution for the interaction problem and optionally for the influence problem is determined as indicated by the control signals and based on the results of the calculations of the interaction problem and optionally the influence problem performed by the quantum computing system and/or a classical computing system. The determined respective interaction parameter and optional influence parameter are then utilized, as indicated by the control signals, in the calculation of the optimization problem. The optimization problem is then calculated in step 860 for determining the optimal target quantities for optimizing the optimization problem in accordance with the control signals and the results of the respective calculations of the quantum computing systems and/or classical computing systems, for instance, in an iterative process. Respective principles are already described above with respect to FIG. 7. The determined optimal target quantities can then be provided to a user, for instance, via a user interface.

Quantum computing is an emerging technology and different hardware realizations exist. Such realizations have for instance evolved into gate-based quantum computers and quantum annealers. Moreover, new hardware realizations are being developed potentially resulting in additional quantum computing paradigms. Thus far a single quantum computing paradigm that serves multiple application problems equally well has not been available. For example, gate-based quantum computers are able to tackle a broad variety of problems including electronic structure problems but are currently also very prone to errors and are thus difficult to improve and scale up, in particular, towards fault-tolerant gate-based quantum computers. On the other hand, quantum annealers are more limited in applicability but simpler to scale up and thus currently provide a larger number of utilizable qubits than gate-based quantum computers for specific problems. Additionally, quantum inspired hardware and algorithms that emulate quantum computers but still run on classical transistor-based computers, such as digital annealers, have become available. Since the space is very diverse from a hardware and computing perspective, it is challenging to utilize quantum computing for real-world scenarios.

The invention suggests in this context, in particular, for materials and chemicals research and development applications, to integrate suitable quantum computing capacities into different steps, for example, of a synthesis process. In particular, the invention, as described above, allows that components of the problem, for instance, part of an optimization problem, can be run on a computing system which can currently best resolve the components' specifics. In particular, in materials and chemicals research and development workflows quantum computing can speed up the process to develop new materials or chemicals or enhance existing materials or chemicals.

In general, the invention refers to a method in which parameters, e.g. interaction and/or influence parameter, in an objective function or model, e.g. an optimization problem, that is connected, for example, to a target performance characteristic of, e.g., a target material, are determined using a suitable quantum computing paradigm in a first step. In a second step, the objective function or model will then be optimized using a potentially different type of quantum computing paradigm that is most suited.

For instance, a materials and chemicals research and development process leveraging quantum computing in different steps in accordance with a preferred application of the above described invention can refer to the following. In a first step of the process gate-based quantum computers, e.g. of the superconducting or trapped-ion type, are used to solve electronic structure problems such as the calculation of energies, reduced density matrices, electron densities, structures, properties, descriptors and orbitals of molecules, solids and materials, as interaction problems. A respective calculation can, for example, be indicated by the provided or generated workflow. While the results of such electronic structure simulations as interaction problem can be directly, or after some inexpensive postprocessing on a classical computer using, for instance, simple mathematical operations like subtraction, used to determine some relevant real-world target quantities such as reaction energies, in many cases further computationally complex and potentially computationally expensive steps need to be carried out to arrive at the final target quantity of interest that is connected to the real-world application. In particular, in most relevant application cases an optimization problem has to be solved based on the result of the calculation of the interaction problem. Thus, in this application based on the previously obtained results from the, optionally, gate-based quantum computing calculation for one or more systems, compositions, configurations, structures and/or specific molecular or material properties, an optimization problem, for example, for predicting further performance characteristics of the molecule, solid or material, is formulated. For example, one of the aims of the optimization can refer to finding the “best” system, composition, configuration, structure, etc. that optimizes an overall real-world target quantity. Exemplary preferred further applications are outlined below.

In a preferred embodiment, the target performance characteristics, i.e. optimal target quantities, are related to the minimization of an objective function as optimization problem that has the form of a many-body Ising model

$$E ( s ) = {\sum }_{i} {h}_{i} {s}_{i} + {\sum }_{〈 i , j 〉} {J}_{ij} {s}_{i} {s}_{j} + {\sum }_{〈 i , j , k 〉} {K}_{ijk} {s}_{i} {s}_{j} {s}_{k} + … \qquad ( 1 )$$

with variables sᵢ taking, preferably, values −1 or 1 and hᵢ, Jᵢⱼ, Kᵢⱼₖ, etc. being coefficients describing local, pairwise and three-body coupling, etc. and thus referring to influence or interaction parameters. The summation in the second term is over all pairwise coupled variables. In some preferred embodiment, only the first and second term of Eq. (1) are considered, such that finding the ground state of the respective Ising Hamiltonian can be reformulated into a quadratic unconstrained binary optimization (QUBO) problem of the form

$$E ( q ) = {\sum }_{i} {a}_{i} {q}_{i} + {\sum }_{i < j} {b}_{ij} {q}_{i} {q}_{j} \qquad ( 2 )$$

with variables qᵢ now taking, preferably, values 0 or 1, bᵢⱼ referring to the interaction parameters of the optimization problem, and aᵢ optionally referring to the influence parameters. Here, again the task is to minimize this objective function as optimization problem. However, of course the objective function can also be easily formulated such that the task refers to a maximization. Moreover, in general, problems including higher order terms, e.g. as already indicated by Eq. (1), problems with constraints and problems that also include continuous variables etc. can in principle also be provided in form of an optimization problem. However, to allow for the most efficient solution using a quantum computer it is preferred that the problem can be mathematically described by Eq. (2).

Several strategies exist, how to solve the optimization problem in Eq. (2) using quantum or classical computers. It is noted, that in many cases optimization problems that at first sight do not seem to have the functional form of Eq. (2) can nevertheless be reformulated to obey Eq. (2). Thus, the invention also when referring to a problem as described above can be utilized for a plurality of different optimization problems that can be reformulated accordingly.

In Eq. (2) the task is to minimize the objective function E. In the case of a quantum annealer there is a simple connection of the mathematical problem, Eq (2), to the hardware level: aᵢ refer to the final qubit biases that can be controlled by external magnetic fields, i.e. the probability of a qubit being measured in one of the two possible states is controlled by the respective external magnetic field, and bᵢⱼ refer to the final coupling strengths between pairs of qubits at the end of the annealing calculation. Furthermore, the measured state of qubit i at the end of the annealing calculation is indicative of an optimal value of variable qᵢ. Parameters aᵢ and bᵢⱼ can be obtained, for example, by means of electronic structure simulations in a first step and then fed into the optimization problem in a second step.

Additional input can also be provided by the user. In particular, the parameter aᵢ referring to an influence parameter can be provided by a user or predetermined instead of calculated in the first step.

Given the current status of quantum computing hardware, a quantum annealer is preferred over a gate-based quantum computer for calculating an optimization problem as described above if the optimization problem has a larger number of variables, i.e. a larger number of qᵢ in Eq. (2). Alternatively, a digital annealer emulating a quantum annealer using classical transistor-based hardware could also be suitable. Thus, in case of a larger number of variables the optimization problem can be more easily calculated on a quantum annealer or digital annealer that currently have a larger number of qubits or bits, respectively, than a gate-based quantum computer. However, the situation is more complex as, for instance, quantum annealers typically have limited connectivity between qubits which again reduces the effective number of variables that can be accommodated. Thus, in many cases the best choice of hardware for a specific problem is often subject to further characteristics of the respective problem and further technical characteristics of the hardware. A workflow for determining which computing system is utilized for which problem can thus be provided or generated based on respective rules. For example, for the above case, a rule can be implemented that indicates that for more than a predetermined number of variables the optimization problem is calculated on a quantum annealer, whereas for less variables a gate-based quantum computer is utilized. A workflow providing unit can then determine the respective number of variables of the optimization problem and generate a corresponding workflow based on the respective rule. Moreover, a further rule can be for the optimization problem that, if i) none of the available quantum computers is suitable, for instance, due to the number of available quantum elements, ii) there are no higher-way interactions in the problem and iii) the number of utilizable bits of a digital annealer is greater than or equal to the number of variables of the problem, utilize a digital annealer. If also a digital annealer is not suitable utilize a classical computing system.

In the following examples of possible advantageous workflows for different problems will be provided. Based on these examples, respective rules can be implemented, for instance, in the workflow providing unit, for providing or generating the workflow accordingly.

If the interaction and/or influence problem can be formulated as electronic structure problems with respective characteristics, it has been found that gate-based quantum computing systems that refer to noisy intermediate-scale quantum computers (NISQ) can advantageously be utilized in the context of variational quantum eigensolvers (VQE) in combination with different ansatze such as hardware-efficient ansatze and the unitary coupled cluster (UCC) ansatz, variational Hamiltonian ansatz (VHA) methods, fermionic quantum Monte Carlo (QMC) methods enhanced by quantum computing. Fault-tolerant gate-based quantum computing systems can be advantageously utilized in the context of quantum phase estimation (QPE) methods. Classical computing systems are preferably utilized in the context of density functional theory (DFT) methods, coupled cluster (CC) methods, configuration interaction (CI) methods, perturbative methods such as Moller-Plesset (MP) perturbation theory and random phase approximation (RPA) methods.

If the interaction and/or influence problem can be formulated as optimization problems and also for the calculation of the optimization problem, it has been found that quantum annealing systems are advantageously utilized in the context of quantum annealing (QA) algorithms and adiabatic quantum computing (AQC) algorithms. NSIQ gate-based quantum computing systems can be utilized for optimization problems in the context of quantum approximate optimization algorithms (QAOA). Fault-tolerant gate-based quantum computing systems can be advantageously utilized for optimization problems in the context of Grover adaptive search (GAS) algorithms. Moreover, classical computing systems can also be utilized in the context of simulated annealing (SA) methods and digital annealers.

It is further noted that generally all quantum computing methods and algorithms can be combined with classical computing within a hybrid quantum-classical framework, which is, for example, naturally the case for all NISQ algorithms, to offload some of the non-critical computational tasks and/or preprocessing and postprocessing steps on a classical computing system. Furthermore, in some embodiment for solving a respective problem, for example, an interaction or optimization problem, also a cascade of different computing paradigms, for instance, different computing systems, can be utilized to achieve higher accuracy and/or larger speed-up. For example, for solving an optimization problem a quantum annealer can be utilized for preoptimization and then a digital annealer can be utilized for the final optimization within a subset of solutions previously determined on the quantum annealer. Thus, also only part of a problem can be calculated by one computing system and other parts or the overall problem can be calculated on another computing system.

Based on the above described principles the structure, composition and/or configuration of a material or chemical product can be optimized with respect to a performance parameter by applying the invention, as described above. The optimized structure, composition and/or configuration can then be provided to a synthesis apparatus for synthesizing the new material or chemical product or a direct connection with the production system can be provided to produce a batch of the tailored material or chemical product as needed. These workflow calculations can lead to new material and chemical product make-ups to tailor performances.

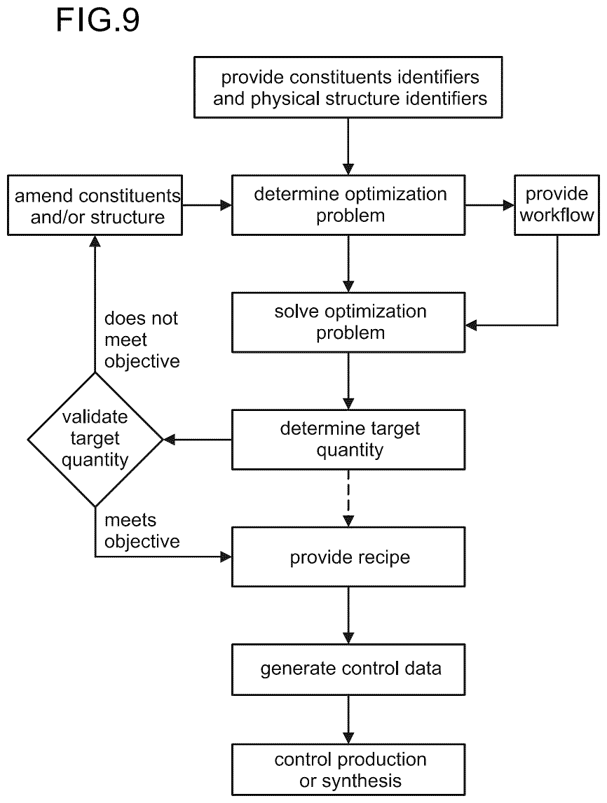

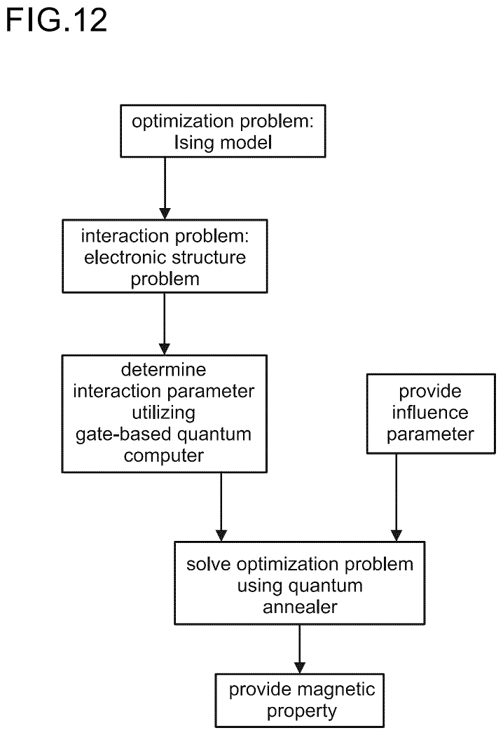

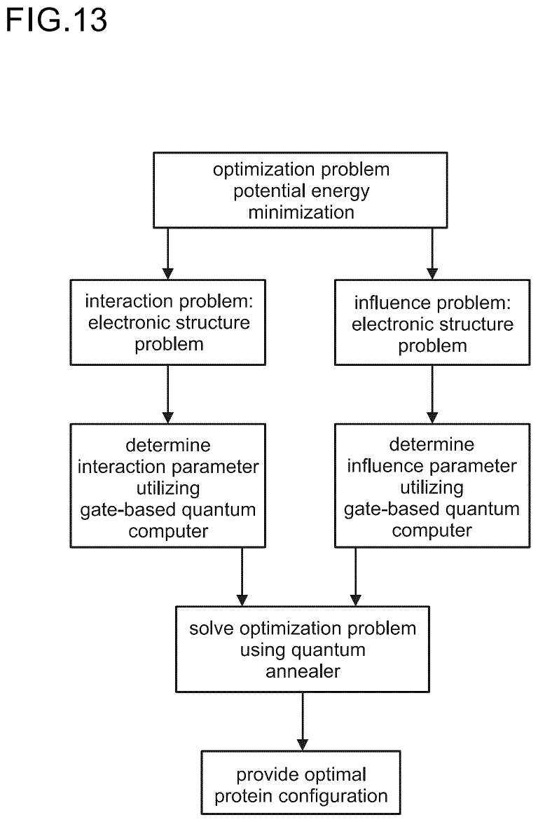

An example for such optimization procedures is described in the following with respect to FIGS. 9 to 11. FIG. 9 shows schematically and exemplarily a general optimization method for a chemical product utilizing the invention as described above. In a first step constituent identifiers and physical structure identifiers are provided, for instance, via an interface unit. For example, the constituent identifiers and the physical structure identifiers can be provided by a user utilizing a respective input unit or can already be stored on a storage communicatively coupled to the interface unit for accessing the storage. The constituents can refer to any part of the chemical product, for example, monomers, molecules, parts of molecules, atoms, etc. The physical structure allows then to identify the relative positions and relations of these constituents in the chemical product. For example, the physical structure indicates where in a polymer respective repeating units, for example, monomers, are positioned or a relative amount of a molecule or material in a mixture. Generally, the constituents and the physical structure can refer to a starting point in the search for a new chemical product that fulfils predetermined objectives. Based on this information, for example, a respective optimization problem as described above can be formulated that describes the respective chemical product and/or one or more properties of the chemical product. Generally, the optimization problem depends on the specific application, in particular, on the chemical product, the constituents and the structure, Moreover, the optimization problem can also depend on the respective objective that a new chemical product should fulfil. For example, the optimization problem can refer to calculating magnetic properties of a chemical product. The such calculated magnetic properties can then be utilized to calculate other properties of the chemical product. The objective can then refer to a certain magnetic property or to another quality or quantity of the chemical product that can be derived from the magnetic property. Some examples of optimization problems for respective applications are described below with respect to FIGS. 12 and 13. Based on the determined optimization problem a workflow for calculating a solution of the optimization problem on one or more quantum computing systems and classical computing systems can then be provided, for example, in accordance with the principles of the invention described above. Moreover, more detailed examples for preferred workflows for specific optimization problems are provided below with respect to FIGS. 12 and 13. Based on the workflow a solution of the optimization problem, i.e. an optimization of the optimization problem, is calculated that is indicative of a target quantity, for instance, a magnetic property, an energy, and/or electron density of one or more configurations and structures of the chemical product. Based on the calculation performed in accordance with the provided workflow the target quantity is then determined. Based on the determined target quantity a performance objective can be determined. In particular, a performance objective can refer to any objective referring to a technical application performance of the chemical product. For example, the performance objective can refer to a target technical application property of the chemical product. Such technical application properties can be derived from the determined target quantity of the chemical product. In this case the determining of the performance objective can refer to validating if the chemical product fulfills the performance objective, for example, meets the target technical application property within predetermined limits. Based on the validation it can be determined if the chemical product meets the objective. If the chemical product meets the objectives a recipe of the chemical product is provided that allows to produce the chemical product with the respective constituents and structure of the chemical product.

If the validation indicates that the objectives are not met by the chemical product, the constituents and/or structure of the chemical product can be amended and the process of determining the optimization problem, solving the optimization problem, determining the target quantity and validating the chemical product can be repeated with the new constituents and/or structure. However, in a variation of this embodiment, the optimization problem can refer to directly calculate different possible configurations of the chemical product, for instance, different constituents and/or different structures. In this case the validation can refer to selecting from the different configurations the configuration that meets the respective objective as much as possible and to directly provide the recipe for this configuration of the chemical product. This variant is indicated by the dashed arrow in FIG. 9. Thus, generally, based on the determination of the performance objective, for example, the validation of the chemical product, one or more constituents and, optionally, also a physical structure of the chemical product, can be selected that should form the final chemical product, i.e. the chemical product that meets the performance objectives. For this chemical product then a recipe can be provided, in particular, indicating the selected constituents and the physical structure of the chemical product. Based on the recipe control data can then be generated that is configured to control a production or synthesis of the chemical product, for example, utilizing respective production or laboratory equipment. The general advantage of utilizing the invention in this context and also in the following application examples, refers to the much faster and also more accurate solution of the optimization problem. Thus, not only the use of computational resources can be decreased, but also real resources for producing the chemical product can be saved. In particular, due to the more accurate solution of the optimization problem also target objective predictions are more accurate and thus producing chemical products that do not fulfil the determined objectives becomes less likely.

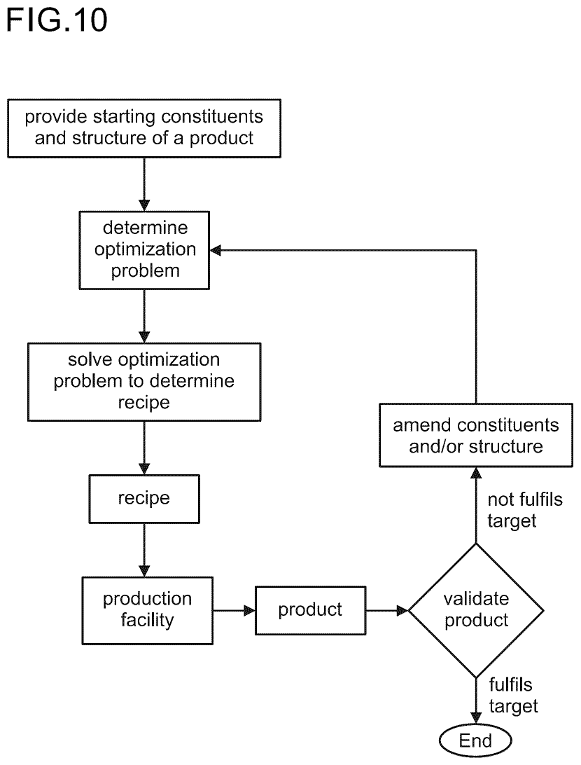

FIG. 10 shows schematically and exemplarily an application of the above described methods in a production environment. In particular, in this example, the methods described above are utilized for optimizing a composition of a chemical product. In this example, first respective starting constituents, for example, in form of constituent identifiers, and a structure of a potential product are provided. Based on this starting information on the potential product the optimization problem is determined. The optimization problem can then be solved utilizing any of the above described embodiments of the invention. Based on the solution of the optimization problem a recipe for a product is provided. Generally, for the above steps the principles described above with respect to FIG. 9 can also be applied in this case. In particular, the optimization procedure described with respect to FIG. 9 can also be applied in this case to determine a recipe. Based on the recipe a production facility is controlled, for example, by controlling the respective production equipment, like valves, mixers, heaters, etc., of the production facility, to produce the product. Optionally, to further optimize the product, the produced product can also be validated. For example, it can be determined if the product fulfils a predetermined target, for example, if the predicted target property determined by the above described method, is also met after a production of the product under real production conditions. In particular, the validation can comprise subjecting the produced product to one or more tests and/or measurement procedures. If the product indeed meets the respective target, the optimization was successful. If the validation indicates that the product does not meet the respective target, a respective amended composition of the product, i.e. amended constituents and/or structure, can be provided or the determined optimization problem can be revised. Based on the new composition and/or based on the new determined optimization problem the process can then be repeated until a product is produced that meets the predetermined target.

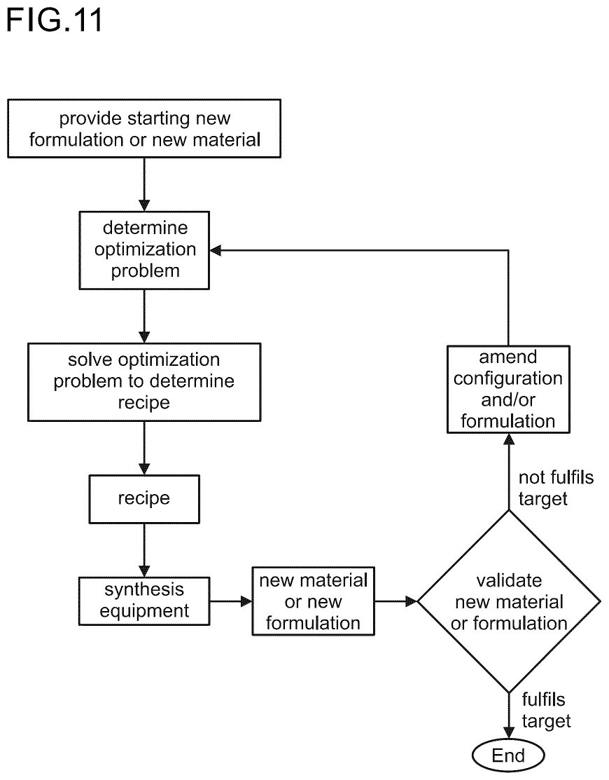

FIG. 11 shows schematically and exemplarily an application of the above described methods to a research and development process for finding new materials or formulations that meet certain target objectives. For example, the new material or new formulation can refer to a new metal alloy composition, a new polymer, a new protein, etc. In a first step one or more possible configurations or compositions of the new material or new formulation can be provided. Based on the starting configurations or compositions the optimization problem can be formulated, for instance, to predict one or more properties of the new material that indicate if the material might be suitable for a certain target objective, for example, for a specific chemical or medical application. The optimization problem can then be solved in accordance with a method of this invention as described above. Based on the solved optimization problem then a recipe is provided of a new material that shows promise to fulfil the respective target objective. Generally, for the above steps the principles described above with respect to FIG. 9 can also be applied in this case. In particular, the optimization procedure described with respect to FIG. 9 can also be applied in this case to determine a recipe. Based on the provided recipe respective laboratory equipment can be controlled to produce, in particular, synthesize, the new material or new formulation. The new material or formulation can then be subjected to a validation procedure, for instance, by performing measurements and testing procedures, to determine if the new material or formulation indeed meets the target objectives. If this is indeed the case the development of the new material or formulation can be successfully completed. If the new material or formulation does not meet the target objectives, the method can comprise amending the configurations or compositions of the new material or new formulation and/or the optimization problem for repeating the procedure.

In the following some preferred applications of the above described embodiments of the invention will be described. A preferred application refers to the calculation of magnetic properties of solid materials, molecular systems and spin systems. A schematic and exemplary workflow for determining a magnetic property in this application is illustrated in FIG. 12. In particular, the workflow illustrated in FIG. 12 can be regarded as an example of a workflow that determines which quantum computing systems and/or classical computing systems are preferably utilized for this application. In the following more details on the preferred workflow and application are described. Generally, an Ising model and/or related models can be used in statistical mechanics to describe spins and magnetism in solid materials, molecular systems and spin systems. The Hamiltonian of the Ising model has the same functional form as Eq. (1) and can be converted into Eq. (2) in case of a quadratic model, which is most common. The variables qᵢ then describe the orientation of the spin, i.e. referring to “spin-up” and “spin-down”, at each site in the system. The optimization problem refers then to minimizing a respective objective function to find the energetically most favorable orientation of the spins, thus determining magnetic properties. The parameters aᵢ referring to the influence parameter describe in this application the strength of an external magnetic field, if present, interacting with the spin at site i, and can be predetermined, for example, as input by a user. The parameters bᵢⱼ referring to the interaction parameter describe in this application a strength of the pairwise coupling between spins at different sites. These coupling strengths can be obtained by calculating electronic structure problems that are preferably provided as interaction problems. For this, the total energy of the system under study, e.g. solid material or molecular system, can be calculated for different spin configurations, e.g. anti-ferromagnetic configuration or, in other words, the singlet configuration and ferromagnetic configuration or, in other words, the high-spin configuration. From the energy difference between different spin configurations the coupling strengths bᵢⱼ and thus the interaction parameters can be deduced. In many cases only few calculations of comparably small electronic structure systems are needed for determining the interaction parameters, in particular, only the energies of few spin configurations and respective structures have to be calculated to determine all relevant and non-redundant pairwise coupling strengths bᵢⱼ, even if the optimization problem is large, e.g. includes many sites. Technical details on how bᵢⱼ can be deduced in the context of classical computing can be found in the article “About the calculation of exchange coupling constants using density-functional theory: The role of the self-interaction error” by E. Ruiz et al., The Journal of Chemical Physics, volume 123, pages 164110-1 to 164110-7 (2005) for molecules and in the article “Relationship between coupling constants in Heisenberg exchange Hamiltonian and Ising model” by S. N. Datta et al., Chemical Physics Letters, volume 621, pages 102 to 108 (2015) for solids.

The Ising model as optimization problem can also be used to describe magnetic properties of molecular magnets, spin glasses, etc. Furthermore, it can be used to describe a lattice gas, i.e. the motion of atoms. Since generally a quantum annealer physically implements the Ising model on the hardware level, it is preferred that the workflow is provided for this case such that the optimization problem is calculated by a quantum annealer or digital annealer. Moreover, since for this application of the Ising model as optimization problem the interaction problem refers to an electronic structure problem, it is preferred that the workflow in this case indicates to utilize a gate-based quantum computing system for calculating at least parts of the interaction problem.

A further preferred application refers to protein design and optimization. A schematic and exemplary workflow for protein design and optimization in this application is illustrated in FIG. 13. In particular, the workflow illustrated in FIG. 13 can be regarded as an example of a workflow that determines which quantum computing systems and/or classical computing systems are preferably utilized for this application. However, also other computing systems can be used. For example, instead of the preferably utilized gate-based quantum computing system used for solving the influence problem as shown in FIG. 13, in some cases it can also be advantageous to utilize a quantum annealing system or classical computing system instead, for instance, if the respective predetermined rules, as exemplarily described above, indicate so. In the following more details on the preferred workflow and application are described. In this application the optimization problem refers to the design and/or optimization of proteins such as enzymes for animal feed or biocatalysts with particular properties and/or biological characteristics. A protein consists of a combination of amino acids. The properties of the protein depend on the choice, sequence and positions of the amino acid building blocks as well as the orientation/conformation of the side chains. This leads to a combinatorial explosion of possibilities, which makes the task of computational protein design and optimization challenging. The task and thus the optimization problem in protein design and optimization refers to identifying the energetically most stable, i.e. lowest-energy, structure out of all those possibilities. The respective optimization problem for this application can in many cases be formulated in the form of Eq. (2), which corresponds to a minimization of the potential energy of the protein during the optimization. In this application, the parameters aᵢ referring to the influence parameters are the energy contribution of a rotamer at a respective position capturing the internal energy of the rotamer at the position as well as interactions of the rotamer at the position with fixed regions in the protein. These can be obtained by calculating electronic structure problems that are preferably provided as influence problems. The parameters bᵢⱼ referring to the interaction parameters describe the pairwise interaction energy between two different rotamers at respective positions. This decomposition of the total potential energy of the protein into pairwise interaction energies leads to the fact that only the interaction energies between nonredundant pairs of rotamers at respective positions need to be known. These can be obtained by calculating electronic structure problems that are preferably provided as interaction problems. In general, an interaction energy can be obtained by subtracting the sum of the total energies of hypothetically non-interacting components from the total energy of the interacting constituents.

Depending on the size and number of non-redundant pairs and positions, further decomposition into smaller subcomponents such as functional groups or other structural units can be advantageous such that the accumulated computational costs for determining the interaction parameter can be reduced in some cases. The electronic structure calculation results for the subcomponents can then be used, for example, to parameterize force fields 35 that finally can be used to determine the pairwise interaction energies bᵢⱼ of the larger components. In some embodiment, it can also be advantageous to combine this approach with group contribution methods. Further details on general methods for solving an optimization problem in this case can be, for instance, found in the article “Computational protein design as an optimization problem” by D. Allouche et al., Artificial Intelligence, volume 212, pages 59 to 79 (2014).

For this application it has been found to be advantageous for most cases to utilize a gate-based quantum computing system for solving the interaction problem referring in most cases to an electronic structure problem. In case that a decomposition into subcomponents is used, it is preferred that for calculating the subcomponents also a gate-based quantum computing system is used, whereas for calculating the force fields based on the results of the subcomponent calculations preferably a classical computing system is utilized. Moreover, based on the calculated force fields the interaction parameters are determined, preferably, also on a classical computing system. The workflow for the optimization problem depends on the respective application and thus on the characteristics of the utilized optimization problem and on the technical details of the respective quantum computing systems, as already described above for other examples. However, it is preferred that the optimization problem is calculated using a quantum annealer or a digital annealer based on the size of the optimization problem.

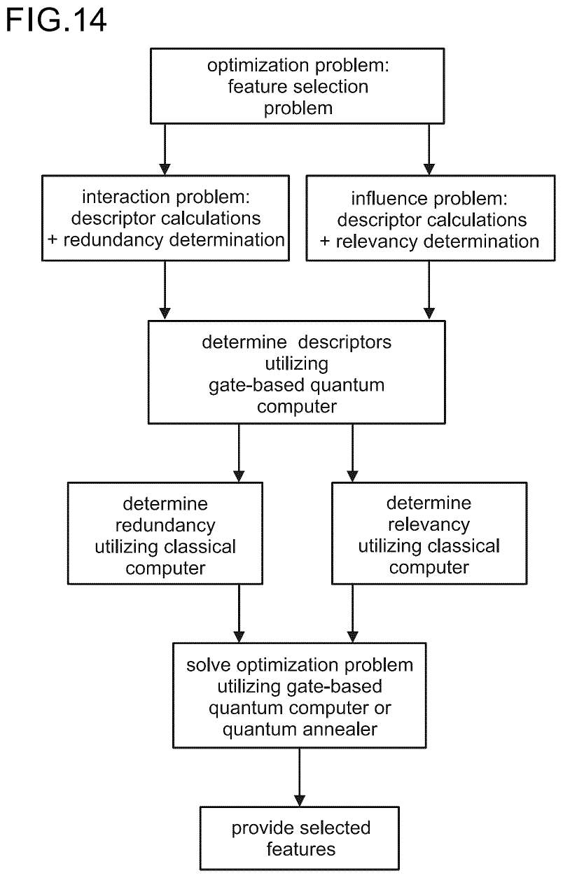

A further application of the method refers to a more general property and performance prediction of chemical products, formulations, polymers, materials, etc. A schematic and exemplary workflow for selecting features for property prediction in this application is illustrated in FIG. 14. In particular, the workflow illustrated in FIG. 14 can be regarded as an example of a workflow that determines which quantum computing systems and/or classical computing systems are preferably utilized for this application. In the following more details on the preferred workflow and application are described. In this more general application, first chemical and/or physical characteristics, for example, physicochemical descriptors are calculated to quantify various electronic and structural properties, e.g. dipole moment, electron affinity, of a set of systems, e.g. a set of molecules. These calculations refer in most cases to electronic structure problems. It has been found by the inventors that the invention can be applied in this context advantageously by regarding these calculations as or as part of the interaction problem and optionally also as part of an influence problem. To generate a comprehensive data set for the following steps in the overall property and performance prediction procedure, typically a large number of systems, e.g. a large number of molecules, needs to be calculated. However, typically, it is possible to extract a large variety of different physicochemical descriptors for a specific system, e.g. molecule, from very few electronic structure calculations or even a single electronic structure calculation. The reason for this is that after having determined some basic quantities as the result of the electronic structure calculation, in particular after having measured some basic quantities on the quantum computer, such as the one and two-particle reduced density matrices, or more general n-particle reduced density matrices, for a specific system, a variety of descriptors can be determined by relatively simple postprocessing of these reduced density matrices on a classical computer. As an example, the total energy of a system is typically calculated by contracting the determined one and two-particle reduced density matrices with Hamiltonian integrals, that can be calculated on a classical computer. As a further example, the dipole moment of the same system is typically calculated by contracting the same one-particle reduced density matrix with dipole integrals that can be calculated on a classical computer. For example, the calculations described above can be performed on gate-based quantum computing systems that are currently limited to a comparably small number of utilizable qubits. In particular, the maximum number of qubits that is needed for the above calculations typically depends on the number of molecular spin orbitals of the largest system. However, also some of the other rules already described more generally above, can be applied to determine a suitable quantum computing system for these calculations as part of the interaction problem.

Generally, these calculations can be regarded as part of the calculation of the interaction problem or influence problem and can be referred to as feature prediction problems, since the generated data set provides the basis for the interaction problem or influence problem.

Based on the above calculations an interaction problem and/or an influence problem can be formulated, wherein the solutions of the interaction and/or influence problem allow for the formulation of a feature selection problem as optimization problem that allows for a feature selection. The feature selection selects a subset of the most relevant and least redundant physicochemical characteristics, e.g. descriptors, out of the entirety of the calculated physicochemical characteristics to predict an overall target quantity/property. For example, in Eq. (2) the interaction parameter bᵢⱼ can then refer to a correlation coefficient, for example, a Pearson correlation coefficient, describing a redundancy of physicochemical characteristics. Preferably, this part of the interaction problem is then calculated from the physicochemical characteristics calculated on the quantum computing system on a classical computing system. The influence parameters aᵢ describe in this embodiment the descriptor relevancy, i.e. the correlation with a respective target property. Depending on the number of systems and the number of physicochemical characteristics calculated, a comparably large data set can result for which it can be advantageous to utilize a quantum or digital annealer for the calculation of the feature selection problem as optimization problem. However, generally, the already above described rules can also be applied to determine the most advantageous workflow for the optimization problem in this application.

In a further step a machine learning model can then be trained based on the previously calculated and selected data to predict an overall target quantity/property, such as solubility of a chemical product or polymer properties. In particular, linear regression, support vector machine classifiers, balanced k-means clustering and neural networks can be formulated as optimization problems obeying also the functional form of Eq. (2). Thus, also for the training of the machine learning model the above described principles of the invention can be applied. Generally, also for the training of the machine learning model as optimization problem, based on the previously calculated and selected data, an interaction problem can be formulated that can be solved according to a workflow following the above already described general principles. More details on possible formulations of the interaction, influence and optimization problem can, for example, be found in the article “QUBO formulations for training machine learning models” by P. Date et al., Scientific Reports, volume 11 (2021) and in the article “Application of Quantum Annealing to Training of Deep Neural Networks” by S. H. Adachi et al., arxiv, pages 1 to 18 (2015). For example, three quantities can be defined referring to i) the training data set comprising the above selected data, ii) regression labels of the training data set in case of the model referring to a regression, classification labels of the training data set in case of the model referring to a support vector machine, and iii) a precision matrix that allows to represent the continuous variables of the original problem as binary variables, such that the resulting optimization problem, i.e. the training problem, is a binary optimization problem. For an example in which the machine learning model should be based on a linear regression, the interaction parameter can be defined to refer to a parameter depending on the training data set X and the precision matrix P and an interaction problem can, for example, be formulated as P^{T}X^{T}X P, wherein T defines the transpose of the respective quantity. An influence parameter can be formulated in dependency on the precision matrix P, the training data set X and the regression labels Y, for instance, mathematically as influence problem −2P^{T}X^{T}Y. The optimization problem refers then to an optimization with respect to the variables of the machine learning model based on the interaction and influence parameters. For an example in which the machine learning model refers to a support vector machine, the interaction parameter can be formulated to depend on the precision matrix, the training data set and the classification labels of the training data set. In this case the influence parameter can be formulated to only depend on the precision matrix. In a further example, the machine learning model can refer to a balanced k-means clustering and the interaction parameter can depend on the training data set, the number of points that each cluster can contain and constraint penalty factors. Preferably, for the calculation of variables of the machine learning model referring to the optimization problem a quantum computing system is utilized. If the model is carefully validated, it can then be used to predict properties of chemical systems that are not contained in the training data set. Depending on the size of the training data set, it might be advantageous to choose a quantum or digital annealer for the calculation of the optimization problem, depending on the above already discussed rules. However, depending on the specific application also a gate-based quantum computing system or a classical computing system can be utilized.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the optimization problem, the interaction problem and the workflow, the generating of the control signals, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. Any embodiments herein are described with reference to acts that are performed by one or more processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

The invention refers to an apparatus for providing control signals to one or more quantum computing systems and/or classical computing systems. A providing unit provides an optimization problem representation comprising an interaction part quantified by an interaction parameter. A problem providing unit provides an interaction problem indicative of an interaction parameter. A providing unit provides a workflow indicating for the optimization and the interaction problem which operations are to be performed on the quantum computing systems or the classical computing systems. The workflow causes that at least a part of the interaction problem is calculated on a quantum computing system and that the optimization problem is calculated on a quantum computing system and/or a classical computing system. A generation unit generates control signals for controlling the one or more quantum computing systems and/or the classical computing systems based on the workflow.

1. Apparatus for providing control signals to one or more quantum computing systems and/or classical computing systems for determining a solution of a problem, wherein the problem is an optimization problem referring to an optimization with respect to at least two variables to find one or more optimal target quantities, wherein the apparatus-comprises:
a problem providing unit for providing an optimization problem, wherein the optimization problem is translatable into an optimization problem representation comprising an interaction part, wherein the interaction part is indicative of a two-way or multi-way interaction between two or more variables of the optimization problem, wherein the interaction in the interaction part is quantified by an interaction parameter,
a parameter problem providing unit for providing an interaction problem, wherein a solution of the interaction problem is indicative of the interaction parameter of the optimization problem,
a workflow providing unit for providing a workflow for utilizing the one or more quantum computing systems for determining the one or more optimal target quantities, wherein the workflow indicates for each of the optimization problem and the interaction problem which operations for solving the respective problem are to be performed on which of the one or more quantum computing systems or the classical computing systems, wherein the workflow is provided such that it causes that at least a part of the interaction problem is calculated on a quantum computing system and that the optimization problem is calculated completely or partly on a quantum computing system and/or a classical computing system,
a control signal generation unit for generating control signals for controlling one or more of the one or more quantum computing systems and/or the classical computing systems based on the workflow, wherein the control signals are generated based on the workflow such that i) the at least a part of the interaction problem is calculated on a quantum computing system and the interaction parameter is determined based on the quantum computer calculation, and ii) that the optimization problem is calculated completely or partly on a quantum computing system and/or a classical computing system-based on the determined interaction parameter and that the optimal target quantities are determined based on the calculated solution of the optimization problem.

2. The apparatus according to claim 1, wherein the workflow providing unit refers to a workflow determination unit for determining the workflow based on one or more characteristics of the optimization problem and/or the interaction problem.

3. The apparatus according to claim 1, wherein the optimization problem further comprises an influence part indicative of an influence on one or more variables of the optimization problem and wherein the influence in the influence part is quantified by an influence parameter, wherein the parameter problem providing unit is further adapted for providing an influence problem, wherein a solution of the influence problem is indicative of the influence parameter, wherein the workflow is provided such that it causes that at least a part of the influence problem is calculated on a quantum computing system, wherein the control signals are generated based on the workflow further such that the i) at least a part of the influence problem is calculated on a quantum computing system and the influence parameter is determined based on the quantum computer calculation, and ii) that the optimization problem is calculated further based on the determined influence parameter.

4. The apparatus according to claim 1, wherein the workflow is provided such that the optimization problem is calculated at least partly on a quantum computing system referring to a quantum annealing system and wherein the control signal generation unit is adapted to generate the control signals for controlling the quantum annealing system such that i) the interaction parameters refer to a final coupling strength between quantum elements of the quantum annealing system and ii) the variables of the optimization problem refer to quantum states of the quantum elements of the quantum annealing system.

5. The apparatus according to claim 1, wherein the optimization problem refers to the calculation of magnetic properties in solid materials or spin systems that can be described utilizing an Ising model, wherein i) the optimization problem can be represented as a Hamiltonian of the Ising model, ii) the interaction parameter describes a coupling strength between spins at different sites in the solid material or spin system, and iii) the variables refer to the orientation of the spins at respective sites in the solid material or spin system.

6. The apparatus according to claim 1, wherein the optimization problem refers to a protein optimization for determining a structure of a protein, wherein i) the interaction parameter refers to an interaction energy of different rotamers at different positions in the protein and ii) the variables refer to respective rotamers at respective positions in the protein.

7. The apparatus according to claim 1, wherein the optimization problem refers to a feature selection problem for selecting a subset of features to predict a predetermined target property, wherein i) the interaction parameter refers to a correlation coefficient describing a redundancy and/or correlation of the features, and ii) the variables refer to a selection state of the respective features.

8. The apparatus according to claim 7, wherein the workflow is provided such that it causes the control signal generation unit- to generate control signals for controlling a quantum computing system such that a plurality of features of material and/or chemical products are determined based on respective feature prediction problems and further to generate control signals to a classical computing system for determining based on the determined features the correlation coefficients of the respective features as interaction parameters.

9. The apparatus according to claim 7, wherein the control signal generation unit is further adapted to generate control signals for controlling a training unit adapted to train a machine learning based property model, wherein the control signals cause the training unit to train the machine learning based property model based on the selected subset of features to predict a target property.

10. A problem solution apparatus for determining a solution of a problem, wherein the problem is an optimization problem referring to an optimization with respect to one or more variables to find one or more optimal target quantities, wherein the optimization problem is translatable into an optimization problem representation comprising an interaction part, wherein the interaction part is indicative of a two-way or multi-way interaction between two or more variables of the optimization problem, wherein the interaction in the interaction part is quantified by an interaction parameter, wherein the apparatus comprises:
a parameter determination unit for determining a solution for the interaction problem, wherein the parameter determination unit is adapted to receive control signals generated by the apparatus according to claim 1 and to determine the interaction parameter based on the results of the calculation of the interaction problem on the quantum computing system and based on the control signals, and
an optimization unit for solving the optimization problem, wherein the optimization unit is adapted to receive control signals generated by the apparatus according to claim 1 and to determine the one or more optimal target quantities based on the solution of the optimization problem calculated completely or partly on the quantum computing system and/or classical computing system and based on the control signals.

11. System for determining a solution of a problem, wherein the system comprises:
an apparatus according to claim 1,
a problem solution apparatus, and
a user interface, for providing an interaction between a user and the apparatus and/or the problem solution apparatus, wherein the interaction comprises providing input to the apparatus and/or the problem solution apparatus, wherein the user interface is further adapted to provide the one or more optimal target quantities to the user,
wherein the problem solution apparatus is for determining a solution of a problem, wherein the problem is an optimization problem referring to an optimization with respect to one or more variables to find one or more optimal target quantities, wherein the optimization problem is translatable into an optimization problem representation comprising an interaction part, wherein the interaction part is indicative of a two-way or multi-way interaction between two or more variables of the optimization problem, wherein the interaction in the interaction part is quantified by an interaction parameter, wherein the apparatus comprises:
a parameter determination unit for determining a solution for the interaction problem, wherein the parameter determination unit is adapted to receive control signals generated by the apparatus according to claim 1 and to determine the interaction parameter based on the results of the calculation of the interaction problem on the quantum computing system and based on the control signals, and
an optimization unit for solving the optimization problem, wherein the optimization unit is adapted to receive control signals generated by the apparatus according to claim 1 and to determine the one or more optimal target quantities based on the solution of the optimization problem calculated completely or partly on the quantum computing system and/or classical computing system and based on the control signals.

12. A system for determining a solution of a problem, wherein the system comprises:
one or more quantum computing systems, and
a system according to claim 11, wherein the system is communicatively coupled to the one or more quantum computing systems for providing control signals for controlling one or more of the quantum computing systems and receiving result signals indicative of results of calculations on the one or more quantum computing systems.

13. A method for providing control signals to one or more quantum computing systems and/or classical computing systems for determining a solution of a problem, wherein the problem is an optimization problem referring to an optimization with respect to one or more variables to find one or more optimal target quantities, wherein the method comprises:
providing an optimization problem, wherein the optimization problem is translatable into an optimization problem representation comprising an interaction part, where-in the interaction part is indicative of a two-way or multi-way interaction between two or more variables of the optimization problem, wherein the interaction in the interaction part is quantified by an interaction parameter,
providing an interaction problem, wherein a solution of the interaction problem is indicative of the interaction parameter of the optimization problem,
providing a workflow for utilizing the one or more quantum computing systems for determining the one or more optimal target quantities, wherein the work-flow indicates for each of the optimization problem and the interaction problem which operations for solving the respective problem are to be performed on which of the one or more quantum computing systems or the classical computing systems, wherein the workflow is provided such that it causes that at least a part of the interaction problem is calculated on a quantum computing system and that the optimization problem is calculated completely or partly on a quantum computing system and/or a classical computing system,
generating control signals for controlling one or more of the one or more quantum computing systems and the classical computing systems based on the workflow, wherein the control signals are generated based on the workflow such that i) the at least a part of the interaction problem is calculated on a quantum computing system and the interaction parameter is determined based on the quantum computer calculation, and ii) that the optimization problem is calculated completely or partly on a quantum computing system and/or a classical computing system based on the determined interaction parameter and that the optimal target quantities are determined based on the calculated solution of the optimization problem.

14. A system for synthesizing or producing a chemical product, in particular, a protein, a solid material, or a polymer, wherein the system comprises:
an interface unit configured to provide constituents identifiers associated with constituents making up the chemical product and physical structure identifiers associated with the relative positions of constituents making up the chemical product,
a processor configured to a) determine a target quantity of one or more configurations of the chemical product based on an optimization problem solved utilizing any of the methods, systems or apparatuses according to claim 1, b) determine a performance objective of the chemical product based on the determined target quantity, and c) select one or more chemical constituents based on the performance objective, and
an interface unit configured to provide a recipe for producing the chemical product based on the selected chemical constituents suitable to control and/or monitor a synthesis or production of a chemical product.

15. A method for synthesizing or producing a chemical product, in particular, a protein, a solid material, or a polymer, wherein the method comprises:
providing constituents identifiers associated with constituents making up the chemical product and physical structure identifiers associated with the relative positions of constituents making up the chemical product,
determining a target quantity of one or more configurations of the chemical product based on an optimization problem solved utilizing the apparatus according to claim 1,
determining a performance objective of the chemical product based on the determined target quantity,
selecting one or more chemical constituents based on the performance objective, and
providing a recipe for producing the chemical product based on the selected chemical constituents suitable to control and/or monitor a synthesis or production of a chemical product.

16. A method for synthesizing or producing a chemical product, wherein the method comprises:
generating a recipe for the chemical product utilizing the system of claim 14, and
synthesizing or producing the chemical product based on the recipe by controlling synthesizing or production equipment, respectively, configured to synthesize or produce the chemical product.

17. A computer program product for providing control signals to one or more quantum computing systems for determining a solution of a problem, wherein the computer program product comprises program code means for causing the apparatus of claim 1 to execute a method for providing control signals to one or more quantum computing systems and/or classical computing systems for determining a solution of a problem, wherein the problem is an optimization problem referring to an optimization with respect to one or more variables to find one or more optimal target quantities, wherein the method comprises:
providing an optimization problem, wherein the optimization problem is translatable into an optimization problem representation comprising an interaction part, where-in the interaction part is indicative of a two-way or multi-way interaction between two or more variables of the optimization problem, wherein the interaction in the interaction part is quantified by an interaction parameter,
providing an interaction problem, wherein a solution of the interaction problem is indicative of the interaction parameter of the optimization problem,
providing a workflow for utilizing the one or more quantum computing systems for determining the one or more optimal target quantities, wherein the work-flow indicates for each of the optimization problem and the interaction problem which operations for solving the respective problem are to be performed on which of the one or more quantum computing systems or the classical computing systems, wherein the workflow is provided such that it causes that at least a part of the interaction problem is calculated on a quantum computing system and that the optimization problem is calculated completely or partly on a quantum computing system and/or a classical computing system,
generating control signals for controlling one or more of the one or more quantum computing systems and the classical computing systems based on the workflow, wherein the control signals are generated based on the workflow such that i) the at least a part of the interaction problem is calculated on a quantum computing system and the interaction parameter is determined based on the quantum computer calculation, and ii) that the optimization problem is calculated completely or partly on a quantum computing system and/or a classical computing system based on the determined interaction parameter and that the optimal target quantities are determined based on the calculated solution of the optimization problem.

18. A method for producing a chemical product comprising using a recipe generated according to claim 14 based on the selected chemical constituents suitable to control and/or monitor a synthesis or production of a chemical product.

19. A method for synthesizing or producing a chemical product, wherein the method comprises:
generating a recipe for the chemical product utilizing the method of claim 15, and
synthesizing or producing the chemical product based on the recipe by controlling synthesizing or production equipment, respectively, configured to synthesize or produce the chemical product.
